(19) United States
(12) Patent Application Publication
(10) Pub. No.: US 2025/0367597 A1
(43) Pub. Date: Dec. 4, 2025

(54) Method and Integrated System for Capturing Carbon

(71) Applicant: Verdus Technologies Pte. Ltd., Singapore (SG)

(72) Inventor: Avichal Agrawal, Singapore (SG)

(21) Appl. No.: 18/875,045

(22) PCT Filed: Jun. 15, 2023
(86) PCT No.: PCT/SG2023/050423

§ 371 Date: Dec. 13, 2024

(30) Foreign Application Priority Data
Jun. 15, 2022 (SG) 10202250162W

(51) Int. Cl. B01D 53/62; B01D 53/75; B01D 53/78; B01D 53/96; B01D 61/02

(52) U.S. Cl. CPC B01D 53/62; B01D 53/75; B01D 53/78; B01D 53/96; B01D 61/025; B01D 2251/40; B01D 2251/608; B01D 2257/504; B01D 2258/0283

(57) ABSTRACT

A method for capturing carbon is provided. The method may comprise a process cycle of: a carbonization process, comprising enriching a feed comprising an aqueous medium with carbon from a carbon dioxide source to form a carbon-rich aqueous medium comprising carbonate ions, and a decarbonization process, comprising removing carbon from the carbon-rich aqueous medium by treating the carbon-rich aqueous medium with a cation capable of forming an insoluble carbonate with the carbonate ions, and removing the insoluble carbonate to form a carbon-deficient aqueous medium; wherein the method comprises carrying out the process cycle for multiple times, with the carbon-deficient aqueous medium of a preceding stage making up the feed for the enriching in a subsequent stage, wherein each of the multiple times uses one or more of (a) a different carbon dioxide source, (b) a different pH, and (c) a different cation.

### CROSS-REFERENCE TO RELATED APPLICATION

This application claims the benefit of priority of Singapore patent application number 10202250162W, filed 15 Jun. 2022, the contents of which being hereby incorporated by reference in its entirety for all purposes.

### TECHNICAL FIELD

Various embodiments refer to methods and integrated systems for capturing carbon.

### BACKGROUND

State of the art methods and systems for capturing carbon, such as carbon dioxide (CO₂) capture, typically focus on capturing carbon from a single source, such as from air or from a source of concentrated CO₂, or from water whereby carbon dioxide is present in dissolved form. Methods that allow carbon capture from more than one source, which may allow for improved processing efficiency and/or provide synergy in terms of use and reuse of generated products and by-products, are still lacking.

For example, carbon capture technology that focuses on capturing carbon from smokestack or flue gas can only capture carbon when the concentration of carbon in the flue gas or smokestack is significantly higher as compared to concentration of carbon in ambient air. However, for a combustion process to take place, there is always ambient air going into a combustion chamber, which may then combine with fuel to form a flue gas. State of the art methods are not able to capture carbon both from the smoke coming out of the combustion chamber as well as the ambient air which is around the combustion chamber or from the air which is going into the combustion chamber. Moreover, current carbon capture technologies that capture carbon from a stream of concentrated carbon dioxide gas are not able to capture 100% of the carbon dioxide and hence there is always some residual carbon dioxide in the exhaust gas stream leaving the carbon capture plant.

In addition to the above, absorbents used to capture carbon from the flue gas are expensive, and hence the absorbents may need to be regenerated at the expense of a large amount of thermal or electrical energy. There is a need for technology that can use low-cost absorbents to avoid the need to regenerate the absorbents. Even though technologies that can further upcycle the carbon rich form of absorbents into a more valuable material may exist, these technologies however use external source of heat or electricity which negatively impacts the carbon footprint and in turn negatively impacts the carbon capture ratio of the end to end process, unless renewable energy such as solar or hydro or wind is used as the input of this external energy, which then requires additional infrastructure and hence adds capital cost to the carbon capture plant setup.

Furthermore, the smoke coming out from a combustion chamber may contain multiple gases such as carbon dioxide, various types of sulfur oxides, nitrous oxides, etc. Currently, carbon capture technology uses different absorbents to capture different components of smoke. This is inefficient because it requires multiple parts and multiple absorbents in a process chain. If any of these parts in the process chain break down, the rest of the process may be severely impacted because the carbon capture absorbent may then be degraded by presence of sulfur oxides gases. There is accordingly a need for a technology that can capture all these components of the smoke simultaneously and efficiently. Moreover, when the different constituent gases like carbon dioxide, sulfur oxides, nitrous oxides are absorbed by the absorbent, and the absorbent subjected to an aqueous medium for subsequent processing, the respective salts or compounds of these gases may be formed in the aqueous medium. This is an impure mixture which is of not much economical value, nor can it be used in an industry because of the presence of several constituent component compounds in the mixture. There is need of a technology that can smartly in-situ segregate these compounds to create a separate salt.

In connection to the above, cations that form insoluble precipitates may be combined with multiple types of anions to form mixed precipitates, such as carbonate precipitate, sulfate precipitate, and hydroxide precipitate. As a result, the precipitates are not pure, unless the medium in which the precipitates are being formed contain only specific types of anions. There is accordingly a need for technology that can ensure that only specific types of anions are present in water, which are being precipitated based on the specific types of cations that are being used to form the precipitates.

State of the art methods that uses cations such as calcium for cyclical carbon capture process require a very high temperature of 900° C. and above to regenerate the absorbent oxides and absorbent hydroxides, and to release a stream of purified carbon dioxide gas, because the thermal decomposition of carbonates is a highly endothermic reaction and draws a large amount of thermal energy. This temperature is very high and requires very specialized equipment.

On the other hand, hydration of calcium oxide to form calcium hydroxide is a highly exothermic reaction that can reach temperatures of well over 200° C., and releases a large amount of thermal energy. In state of the art technology, a very dilute form of sodium hydroxide absorbent is used and hence there is a large amount of water contained in the absorbent, which is why energy released by hydration of calcium oxide is spread over the large quantity of water, thereby raising the temperature of water by only a few ° C., which essentially means that there is wastage of the thermal energy for practical usage.

State of the art technology is not able to efficiently use zinc cycle for carbon capture because zinc cation forms insoluble precipitates with both hydroxides as well as carbonates, which are both present in the alkaline aqueous carbon capture medium. Although the calcination step for zinc operates at a much lower temperature of about 400° C., much of the thermal energy (nearly 50%) is wasted in the calcination of zinc hydroxide, because precipitate contains both zinc hydroxide as well as zinc carbonate. Also, the stream of pure CO₂ gas produced by this calcination contains both water vapor (steam) as well as carbon dioxide, instead of a more desirable pure CO₂ gas stream.

In light of the above, there is still a need for improved methods and integrated systems for capture of carbon that alleviates one or more of the above problems.

### SUMMARY

In a first aspect, there is provided a method for capturing carbon, comprising a process cycle of: a carbonization process, comprising enriching a feed comprising an aqueous medium with carbon from a carbon dioxide source to form a carbon-rich aqueous medium comprising carbonate ions, and a decarbonization process, comprising removing carbon from the carbon-rich aqueous medium by treating the carbon-rich aqueous medium with a cation capable of forming an insoluble carbonate with the carbonate ions, and removing the insoluble carbonate to form a carbon-deficient aqueous medium; wherein the method comprises carrying out the process cycle for multiple times, with the carbon-deficient aqueous medium of a preceding stage making up the feed for the enriching in a subsequent stage, wherein each of the multiple times uses one or more of (a) a different carbon dioxide source, (b) a different pH, and (c) a different cation.

In a second aspect, there is provided an integrated system for capturing carbon, comprising multiple sets of a carbonization unit operable to enrich a feed comprising an aqueous medium with carbon from a carbon dioxide source to form a carbon-rich aqueous medium comprising carbonate ions, and a decarbonization unit operable to remove carbon from the carbon-rich aqueous medium by treating the carbon-rich aqueous medium with a cation capable of forming an insoluble carbonate with the carbonate ions, and removing the insoluble carbonate to form a carbon-deficient aqueous medium; wherein each carbonization unit and decarbonization unit of the multiple sets uses one or more of (a) a different carbon dioxide source, (b) a different pH, and (c) a different cation.

In a third aspect, there is provided use of the method according to the first aspect or the integrated system according to the second aspect in one or more of treatment of water, ambient air, and flue gas, and carbon dioxide recovery.

### BRIEF DESCRIPTION OF THE DRAWINGS

In the drawings, like reference characters generally refer to the same parts throughout the different views. The drawings are not necessarily drawn to scale, emphasis instead generally being placed upon illustrating the principles of various embodiments. In the following description, various embodiments of the invention are described with reference to the following drawings.

FIG. 1A is a schematic diagram depicting a method of capturing carbon comprising alternate cycles of carbonization and decarbonization according to embodiments. Three cycles of carbonization and decarbonization, and thermal exchange of heat between the cycles are shown. As can be seen, the method disclosed herein as not simply three cycles of carbonization and decarbonization put together. There is presence of synergy between the cycles, as well as interloping of energy resulting in improvements such as better energy efficiency, higher speed, and lower/smaller infrastructure.

FIG. 1B is a schematic diagram depicting a method of capturing carbon comprising alternate cycles of carbonization and decarbonization according to embodiments. Three cycles of carbonization and decarbonization, and thermal exchange of heat between the cycles are shown. As can be seen, the method disclosed herein as not simply three cycles of carbonization and decarbonization put together. There is presence of synergy between the cycles, as well as interloping of energy, water, and CO₂ between the process cycles resulting in improvements such as better energy efficiency, higher speed, and lower/smaller infrastructure.

FIG. 2 is a schematic diagram depicting an example of overall water flow for a method of capturing carbon.

FIG. 3 is a schematic diagram depicting an example of overall gas flow for a method of capturing carbon.

FIG. 4 is a schematic diagram depicting an example of overall water and gas flow for a method of capturing carbon.

FIG. 5 is a schematic diagram depicting an example of a first water carbonization stage.

FIG. 6 is a schematic diagram depicting an example of a first water decarbonization stage.

FIG. 7 is a schematic diagram depicting an example of output gas stream post-processing.

FIG. 8 is a schematic diagram depicting an example of a second water carbonization stage.

FIG. 9 is a schematic diagram depicting an example of a second water decarbonization stage.

FIG. 10 is a schematic diagram depicting an example of a water sulfurization stage.

FIG. 11 is a schematic diagram depicting an example of a water desulfurization stage.

FIG. 12 is a schematic diagram depicting an example of a third water carbonization stage.

FIG. 13 is a schematic diagram depicting an example of a third water decarbonization stage.

FIG. 14 is a schematic diagram depicting an example of output water post-processing.

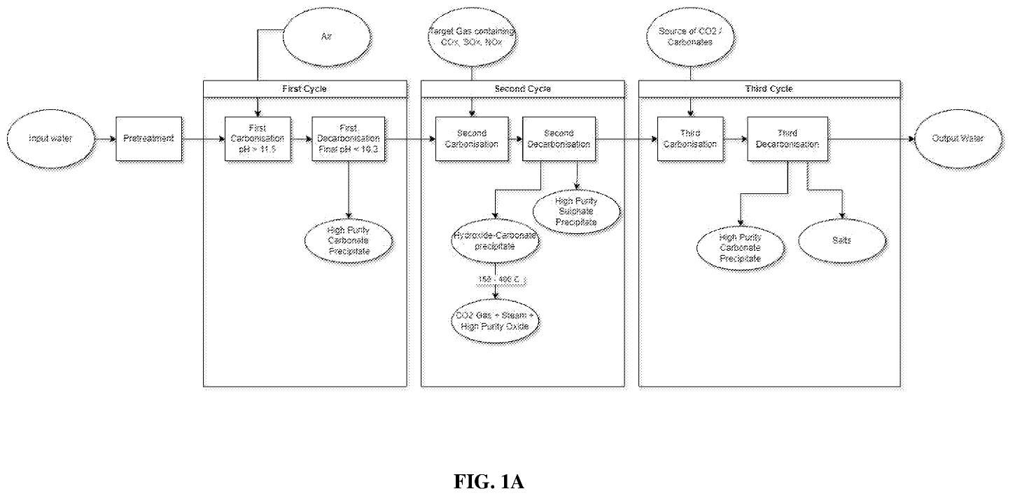

### DESCRIPTION

The following detailed description refers to the accompanying drawings that show, by way of illustration, specific details and embodiments in which the invention may be practised. These embodiments are described in sufficient detail to enable those skilled in the art to practise the invention. Other embodiments may be utilized and structural, logical, and electrical changes may be made without departing from the scope of the invention. The various embodiments are not necessarily mutually exclusive, as some embodiments can be combined with one or more other embodiments to form new embodiments.

Advantageously, methods disclosed herein are able to capture carbon dioxide from a myriad of sources such as water, and air, and from a source of concentrated carbon dioxide such as flue gas or even a stream of nearly pure carbon dioxide. Methods disclosed herein are able to capture carbon from ambient air as well as from flue gas or smokestack, and from exhaust gas from a plant such as a carbon capture plant whereby low concentration levels of carbon may be present.

In other words, methods disclosed herein can capture carbon not only from highly concentrated forms such as flue gas or smokestack which are typically used in carbon capture plants, but also from the very low concentration of carbon dioxide in ambient air. Therefore, methods disclosed herein are able to provide 100%, or even higher ratio of capture of the carbon dioxide, by accumulating both the capture of partial amount of carbon dioxide from the flue gas plus the capture of carbon dioxide from the ambient air or from the exhaust air coming out from the carbon capture plant.

Regarding the absorbents used, the carbon-rich form of absorbent after being subjected to a carbon capture process may be processed into another intermediate carbonate material, which may then be processed into a highly purified form by using thermal energy that is already flowing within the process. In so doing, the highly purified final product may be more valuable than the input low-cost carbon-deficient absorbent, without negatively impacting the ratio of carbon capture of the end-to-end process.

Furthermore, use of multiple kinds of absorbents may be avoided as methods disclosed herein are able to use a single kind of absorbent, as all the constituents such as carbon dioxide and various forms of sulphur oxides and nitrous oxides may be captured by using the same carbon capture absorbent. In embodiments whereby a cation is used that is capable of forming precipitates of both carbonate as well as sulphate, the aqueous medium may first be decarbonized before the sulphate is precipitated, and hence only sulphate is precipitated, and instead of a mixture of carbonate and sulphate precipitate.

With the multiple cycles of carbonization and decarbonization, different kinds of salts may be generated, processed and/or extracted in both carbon-rich and carbon-deficient states in respective carbonization and decarbonization steps. As such, there can be in-situ segregation of the salts to improve ease of their storage and/or reuse.

As compared to state of the art methods that uses cations such as calcium for cyclical carbon capture process which require very high temperatures of 900° C. and above to regenerate the absorbent oxides and absorbent hydroxides, methods disclosed herein may relate to use of calcination temperatures at a significantly lower temperature at only about 400° C., which means that it is less energy intensive.

In various embodiments, calcium oxide may be hydrated in a highly concentrated manner, wherein the heat of hydration released when calcium oxide is hydrated to form calcium hydroxide can be reused to calcine the zinc hydroxide at temperatures below 200° C. In so doing, this may significantly reduce proportion of zinc hydroxide as compared to zinc carbonate in zinc precipitate formed during the carbon capture process according to embodiments. The lower proportion of zinc hydroxide, coupled with reuse of thermal energy to calcine the zinc hydroxide, which may also be effectively recaptured and reutilized, means that loss of energy in the calcination of zinc hydroxide may be mitigated in embodiments.

With the above in mind, various embodiments refer in a first aspect to a method for capturing carbon, comprising a process cycle of: a carbonization process, comprising enriching a feed comprising an aqueous medium with carbon from a carbon dioxide source to form a carbon-rich aqueous medium comprising carbonate ions, and a decarbonization process, comprising removing carbon from the carbon-rich aqueous medium by treating the carbon-rich aqueous medium with a cation capable of forming an insoluble carbonate with the carbonate ions, and removing the insoluble carbonate to form a carbon-deficient aqueous medium.

By the term “capturing carbon”, otherwise termed herein as “capturing carbon dioxide” or “removing carbon dioxide”, this means at least reducing an amount of the carbon dioxide in the carbon dioxide source following application of methods disclosed herein. For example, amount of carbon dioxide removed following application of methods disclosed herein may be 1 wt %, 10 wt %, 30 wt %, 50 wt % 70 wt %, 80 wt %, 85 wt %, 90 wt %, or 95 wt % of what was originally present in the carbon dioxide source. In some embodiments, the carbon dioxide is at least substantially removed or is completely removed from the carbon dioxide source, whereby the term “substantially” may refer to at least 80 wt %, which may be achieved as accumulation of removal from the air and the removal from flue gas or other sources.

Non-limiting examples of a carbon dioxide source may, for example, be one or more of ambient air, flue gas from a combustion chamber, a biogas with a high concentration of carbon dioxide, purified CO₂ gas, a sulphur-free target gas containing carbon dioxide, a carbonate salt, and carbonate ions comprised in an aqueous medium.

The process cycle disclosed herein comprises a carbonization process and a decarbonization process. Methods disclosed herein may include carrying out the process cycle for multiple times, such as three times or more. Accordingly, this may mean that there is a first carbonization process and a first decarbonization process corresponding to carrying out the process cycle for a first time; a second carbonization process and a second decarbonization process corresponding to carrying out the process cycle for a second time; a third carbonization process and a third decarbonization process corresponding to carrying out the process cycle for a third time, and so on. In various embodiments, methods disclosed herein comprises carrying out the process cycle for three times.

The carbon-deficient aqueous medium of a preceding stage may make up the feed for the enriching in a subsequent stage. For example, in embodiments wherein the process cycle is carried out for three times, carrying out the process cycle for the first time may comprise a first carbonization process, comprising enriching a feed comprising an aqueous medium with carbon from a carbon dioxide source to form a carbon-rich aqueous medium comprising carbonate ions, which may be channeled to a first decarbonization process comprising removing carbon from the carbon-rich aqueous medium by treating the carbon-rich aqueous medium with a cation capable of forming an insoluble carbonate with the carbonate ions, and removing the insoluble carbonate to form a carbon-deficient aqueous medium. When treating the carbon-rich aqueous medium with the cation, contact between the aqueous medium and the carbon dioxide source may be maintained. Carrying out the process cycle for the second time may comprise a second carbonization process, wherein the carbon-deficient aqueous medium from the first decarbonization process may constitute the feed for the second carbonization process, and may be enriched in the second carbonization process with carbon from a carbon dioxide source to form a carbon-rich aqueous medium comprising carbonate ions, which may be channeled to a second decarbonization process comprising removing carbon from the carbon-rich aqueous medium by treating the carbon-rich aqueous medium with a cation capable of forming an insoluble carbonate with the carbonate ions, and removing the insoluble carbonate to form a carbon-deficient aqueous medium. The carbon-deficient aqueous medium from the second decarbonization process may constitute the feed for a third carbonization process, whereby it may be enriched in the third carbonization process with carbon from a carbon dioxide source to form a carbon-rich aqueous medium comprising carbonate ions, which may be channeled to a third decarbonization process comprising removing carbon from the carbon-rich aqueous medium by treating the carbon-rich aqueous medium with a cation capable of forming an insoluble carbonate with the carbonate ions, and removing the insoluble carbonate to form a carbon-deficient aqueous medium.

As mentioned above, carrying out the process cycle for the first time may comprise a first carbonization process, comprising enriching a feed comprising an aqueous medium with carbon from a carbon dioxide source to form a carbon-rich aqueous medium comprising carbonate ions.

The term “enriching” as used herein refers to increasing amount or concentration of a substance. Accordingly, the carbon-rich aqueous medium may contain a higher amount or concentration of carbon as compared to the aqueous medium. The term “aqueous medium” may refer to a liquid with water as major phase. For example, water content in the aqueous medium may be at least 50% by weight of the aqueous medium, such as at least 60%, at least 65%, at least 70%, at least 75%, at least 80%, at least 85%, at least 90%, or at least 95%.

The aqueous medium may, for example, be from a natural source, such as rainwater, river water, lake water or seawater, and/or from household such as well water or tap water, and/or from industry such as brine from a water desalination plant or wastewater from an industrial boiler. In various embodiments, the aqueous medium comprised in the feed when carrying out the process cycle for the first time is water.

The aqueous medium may be filtered to remove undissolved impurities and/or suspended particles prior to its use in a method disclosed herein. In addition or alternatively, the aqueous medium may be sanitized to remove bacteria prior to its use in a method disclosed herein.

In various embodiments, the method further comprises, prior to carrying out the process cycle, pre-treating the feed comprising the aqueous medium with an acid to achieve a pH value of 4 or less, for example, 3.5 or less, 3 or less or 2.5 or less, and subsequently treating with an alkali to increase its pH to 10.5 or more, such as 11 or more, 11.5 or more, 12 or more, or 12.5 or more, and removing any carbon dioxide evolved and precipitate formed as a result of the pre-treating. In so doing, this may mean that the feed to the first carbonization process is free, or at least substantially free, of carbon dioxide. The carbon dioxide that is evolved may form at least part of the carbon dioxide source when carrying out the process cycle for a third or subsequent time.

The acid may be a non-carbonic acid, such as hydrochloric acid.

The alkali may be an alkali metal hydroxide, for example, hydroxides of a Group I element such as sodium and potassium. Sodium based chemicals may advantageously be used as they may make methods disclosed herein more economically viable. In pre-treating the aqueous medium with an alkali metal hydroxide, any carbon dioxide present in the aqueous medium may form an alkali metal carbonate, which may, for example, be a carbonate of a Group I element such as sodium carbonate and potassium carbonate. If the aqueous medium contains cations such as calcium or magnesium which form insoluble carbonate salts of solubility less than 1 gram/litre, some carbonate precipitate may precipitate out of the water solution. Advantageously, this may allow at least some or most of the above-mentioned cations, which may otherwise remain in the aqueous medium, to be removed from subsequent processing. In so doing, formation of undesirable by-products downstream may be avoided. Precipitates formed by the cations may be removed easily from the aqueous medium using a separation process such as filtration or centrifugation.

The carbon dioxide source when carrying out the process cycle for the first time may be ambient air. Sources of ambient air may include, but are not limited to, ducts providing airflow out from an indoor such as a commercial building, or ducts providing airflow to a combustion system, or ambient air from a ventilated arrangement.

In various embodiments, carrying out the process cycle for a first time comprises enriching the feed by contacting the feed with the carbon dioxide source, and treating the feed with an alkali while the contacting is carried out to form the carbon-rich aqueous medium comprising carbonate ions, wherein the carbon-rich aqueous medium has a pH value of at least 11.5.

The alkali may be an alkali metal hydroxide, for example, hydroxides of a Group I element such as sodium and potassium. Sodium based chemicals may advantageously be used as they may make methods disclosed herein more economically viable.

pH of the carbon-rich aqueous medium may be at least 11.5, such as at least 12, at least 12.5, or at least 13.

In various embodiments, carrying out the process cycle for a first time comprises removing carbon from the carbon-rich aqueous medium by treating the carbon-rich aqueous medium with an alkaline earth cation to form an insoluble alkaline earth carbonate, wherein treating the carbon-rich aqueous medium with an alkaline earth cation is carried out while the carbon-rich aqueous medium is contacted with the carbon dioxide source, and removing the insoluble carbonate to form the carbon-deficient aqueous medium, wherein the carbon-deficient aqueous medium has a pH value of 10.3 or below.

Examples of alkaline earth cation may include calcium and magnesium.

pH of the carbon-deficient aqueous medium may be 10.3 or below, such as 10 or below, 9.5 or below, 9 or below, 8.5 or below, or 7 or below.

If any cations such as magnesium are present, where the hydroxide salt is less soluble than the carbonate salt, then hydroxide precipitates of such cations may be formed.

As disclosed herein, each of the multiple times uses one or more of (a) a different carbon dioxide source, (b) a different pH, and (c) a different cation. Depending on the type of different carbon dioxide source, a different pH, and/or a different cation may be used according to methods disclosed herein for capturing carbon.

Carbon dioxide source when carrying out the process cycle for the second time may be flue gas from a combustion chamber or a biogas with a high concentration of carbon dioxide.

The term “gas” as used herein refers to a substance in the gaseous state such as ambient air and flue gas, and may also include vapours. The term “flue gas”, otherwise termed herein as “exhaust gas”, refers to gas having a higher or much higher carbon dioxide content as compared to ambient air, and may be emitted from combustion processes such as ovens and car engines and/or industry such as factories.

In some embodiments, the carbon dioxide source when carrying out the process cycle for the second time may comprise SOx. SOx may be partly present in the carbon dioxide source, and content may vary depending on the carbon dioxide source used.

In embodiments where the carbon dioxide source when carrying out the process cycle for the second time comprise SOx, carrying out the process cycle for a second time may comprise enriching the feed by contacting the feed with the carbon dioxide source, and treating the feed with an alkali while the contacting is carried out to form the carbon-rich aqueous medium comprising carbonate ions, wherein the carbon-rich aqueous medium further comprises hydroxide ions.

Examples of alkali that may be used include hydroxides of Group 1 alkali metals, such as sodium hydroxide or potassium hydroxide.

In embodiments where the carbon dioxide source when carrying out the process cycle for the second time comprise SOx, carrying out the process cycle for a second time comprises removing carbon from the carbon-rich aqueous medium by treating the carbon-rich aqueous medium with a cation capable of forming an insoluble carbonate but incapable of forming an insoluble sulphate in the presence of carbonate ions and excess hydroxide ions, wherein the cation is provided by a highly soluble halide salt such as a chloride salt, a sulphate salt, or a highly soluble nitrate salt, and removing the insoluble hydroxide-carbonate as a precipitate to form a carbon-deficient aqueous medium.

The cation that may be used may be zinc, and may be present in salts such as zinc chloride, zinc sulphate, and zinc nitrate, as well as zinc oxide or zinc hydroxide.

In specific embodiments, the cation is provided by a sulphate salt such as zinc sulphate. Use of a sulphate salt may be advantageous, as it may allow maximization of conversion of low cost strontium hydroxide to highly valued strontium sulphate to be achieved in a next step and with lowest infrastructure costs. Although a chloride salt may alternatively be used, further downstream treatment such as reverse osmosis, distillation or electrolysis may be required to purify an output from the process such as water. For a nitrate salt, it may be possible to conduct more process cycles before output from the process such as water is purified. In some embodiments, the nitrate water brine may be sold as a fertilizer.

In some embodiments, the insoluble hydroxide-carbonate is a mixture of calcium hydroxide and calcium carbonate.

In various embodiments, the insoluble hydroxide-carbonate is a mixture of zinc hydroxide and zinc carbonate. Zinc sulphate precipitate may not form at lower concentration level. Furthermore, zinc may precipitate preferentially as zinc carbonate and/or zinc hydroxide in the presence of carbonate ions and/or hydroxide ions. As such, higher concentration levels of zinc sulphate may not be reached thereby minimizing the potential for zinc sulphate to precipitate.

Methods disclosed herein may further comprise subjecting the hydroxide-carbonate precipitate to a heat treatment to release steam, or CO₂ gas, or a mixture of steam and CO₂ gas, wherein preferably, thermal energy for the heat treatment comprises thermal energy channeled from carrying out the process cycle for a first time. The heat treatment may be carried out at a temperature in the range from 150° C. to 400° C. in an enclosed environment. Advantageously, temperatures used herein are much lower than state of the art methods relating to generation of carbon dioxide from heating CaCO₃, for example, whereby much higher temperatures of 900° C. are needed due to higher heat of dissociation of CaCO₃.

By heating in an enclosed environment, the heating product formed may advantageously be controlled or varied by controlling the temperature. Furthermore, the heating product, which may be substantially in its pure form, may be stored for subsequent use. This contrasts with heating processes carried out in a non-enclosed environment, whereby the heating products of steam and/or CO₂ gas are liberated to the environment, even though a lower temperature such as 300° C. may possibly be used. Depending on the temperature used, steam, or CO₂ gas, or a mixture of steam and CO₂ gas may be released. When the hydroxide-carbonate precipitate is heated from 150° C., for example, the hydroxide comprised in the hydroxide-carbonate precipitate may be converted to steam. When temperature is increased to 250° C., it may be the case that all of the hydroxide is converted to steam, and only carbonate remains in the precipitate, such that when temperature is further increased to 300° C., only CO₂ is liberated.

In embodiments where the insoluble hydroxide-carbonate is a mixture of zinc hydroxide and zinc carbonate, high purity zinc oxide may be produced using methods disclosed herein, which is a valuable product that can be sold or used directly. Likewise, the carbon dioxide that is produced may be of a high purity that can be used directly or be stored for sale.

Thermal energy may be recovered from the steam and/or CO₂ gas, and the recovered thermal energy may be used along with thermal energy recovered from other process cycles for the heat treatment, and/or one or more of the carbonization process and the decarbonization process, and/or pre-treating of the feed if the pre-treating is carried out, and/or heating precipitate formed from one or more of the process cycles.

In use of the recovered thermal energy for the heat treatment, the recovered thermal energy may be used to pre-heat the carbonate-hydroxide precipitate to improve carbonate to hydroxide ratio. In some embodiments, recovering the thermal energy may comprise cooling outputs from the heat treatment from a temperature of about 400° C. to about 150 to 200° C. In the temperature range from 150 to 200° C., any water that may be present remains in the vapor form. Accordingly, the water that forms from the heat treatment process may be used, for example, when carrying out the process cycle for a third time to thermally treat the carbon-deficient aqueous medium so as to generate pure distilled water, and/or be used to heat precipitate formed from one or more of the process cycles so as to dry them out.

By using the recovered thermal energy for one or more of the carbonization process and the decarbonization process, either one or both processes may be run at temperatures above ambient temperature, which may by itself be already advantageous, particularly in cold or winter climates. Advantageously, methods disclosed herein involving multiple runs of the carbonization process and the decarbonization process are able to provide synergy, in terms of how the outputs from one cycle may be used for another cycle with value add, and in terms of thermal energy usage within the method.

In some embodiments, CO₂ gas is released, and the CO₂ gas forms at least part of the carbon dioxide source when carrying out the process cycle for a third or subsequent time.

In some embodiments when carrying out the process cycle for a second time, the carbon-deficient aqueous medium may comprise sulphate ions. The method may further comprise treating the carbon-deficient aqueous medium with a cation capable of forming an insoluble sulphate with the sulphate ions, wherein the cation is provided by a hydroxide salt or a halide salt such as a chloride salt or a highly soluble nitrate salt, and removing the insoluble sulphate to form a carbon-deficient aqueous medium, wherein the carbon-deficient aqueous medium is also sulphate-deficient.

Examples of cations capable of forming an insoluble sulphate with the sulphate ions include strontium and barium. In various embodiments, the cation is strontium and salts such as strontium chloride, or strontium hydroxide may be added. Strontium hydroxide may advantageously be used over strontium chloride, so as to avoid further processing involving reverse osmosis, distillation or electrolysis type of purification in case of chloride built-up.

Carrying out the process cycle for a third time may comprise enriching the carbon-deficient and sulphate-deficient aqueous medium by contacting the feed with the carbon dioxide source, and treating the feed with an alkali or a basic salt while the contacting is carried out to form the carbon-rich aqueous medium comprising carbonate ions, wherein the carbon dioxide source is one or more of ambient air, purified CO₂ gas, a sulphur-free target gas, and carbonate ions, and wherein precipitate if formed is removed. In some embodiments, the carbon dioxide source is one or more of a purified CO₂ gas, a sulphur-free target gas, and carbonate ions.

Examples of alkali include hydroxides of Group 1 alkali metals such as sodium and potassium and water-soluble hydroxides of alkaline earth metals such as strontium. In various embodiments, sodium carbonate may be converted to sodium bicarbonate as the basic salt.

According to methods disclosed herein, carrying out the process cycle for a third time may further comprise generating an alkali and output water with reduced concentration of salt from the carbon-deficient aqueous medium by using electrical energy, wherein the carbon-deficient aqueous medium is in the form of a brine containing a sufficiently high concentration of dissolved salts produced after carrying out the process cycle for a third time, wherein the alkali is channeled to a different process cycle for use, and the output water is channeled into the carbonisation cycle when carrying out the process cycle for a first time. By channeling the output water into the carbonisation cycle when carrying out the process cycle for a first time, saturation level of salt in the carbon-deficient aqueous medium for efficient electrolysis, so as to allow electrical splitting into acid and base, may be achieved. Examples of the alkali include hydroxides of Group 1 alkali metals such as sodium and potassium and water-soluble hydroxides of alkaline earth metals such as strontium.

Methods disclosed herein may further comprise using the carbon-deficient aqueous medium formed in the decarbonization process when carrying out the process cycle for the second and subsequent times, as at least part of the aqueous medium of the carbonization process when carrying out the process cycle for the first time. For example, carbon-deficient aqueous medium formed in the decarbonization process when carrying out the process cycle for the third time may be used as at least part of the aqueous medium of the carbonization process when carrying out the process cycle for the first time. The carbon-deficient aqueous medium may be treated to one or more of (a) a reverse-osmosis process and (b) distillation process, before using the treated carbon-deficient aqueous medium as at least part of the aqueous medium of the carbonization process when carrying out the process cycle for the first time, wherein preferably, precipitates formed during one or more of the process cycles act as the heat sink for condensation of water vapour in the distillation process. In so doing, an external heat sink may not be required. At the same time, precipitate formed during one or more of the process cycles may be dried up using thermal energy generated from methods disclosed herein, and the dried precipitate may be packaged and sold, while water that is condensed from the water vapor may be reused in the process cycles. Furthermore, a distillation process may be used herein without further processing of the carbon-deficient aqueous medium to remove calcium impurities, in view that the carbon-deficient aqueous medium formed in the decarbonization process after carrying out the process cycle for the third time may already be decarbonated, desulphurized and calcium-deficient.

In various embodiments, thermal energy is generated from one or more of the process cycle, and the generated thermal energy is channeled to a different process cycle for use. For example, embodiments wherein a distillation process is used for treating carbon-deficient aqueous medium, thermal energy for the distillation may be sourced from one or more of the process cycles.

Various embodiments refer in a second aspect to an integrated system for capturing carbon. The integrated system may comprise multiple sets of a carbonization unit operable to enrich a feed comprising an aqueous medium with carbon from a carbon dioxide source to form a carbon-rich aqueous medium comprising carbonate ions, and a decarbonization unit operable to remove carbon from the carbon-rich aqueous medium by treating the carbon-rich aqueous medium with a cation capable of forming an insoluble carbonate with the carbonate ions, and removing the insoluble carbonate to form a carbon-deficient aqueous medium; wherein each carbonization unit and decarbonization unit of the multiple sets are adapted to use one or more of (a) a different carbon dioxide source, (b) a different pH, and (c) a different cation.

Examples of suitable aqueous medium, carbon dioxide source, pH, and cation have already been discussed above.

As used herein, the term “integrated system” refers to a single system which can be used for capturing carbon from various carbon dioxide sources. The components making up the integrated system may be in fluid communication with one another so that output generated from an upstream component may be channeled to and be used in a downstream component, and vice versa.

Advantageously, there may be synergy between the various components of the integrated system, giving rise to improved productivity and efficiency. The integrated system may also be more environmentally friendly as compared to state of the art processes due to use or reuse of the outputs to a greater extent within the integrated system.

A separation unit operable to remove precipitate from the aqueous medium, carbon-rich aqueous medium and/or carbon-deficient aqueous medium may further be comprised in the integrated system. Examples of separation unit may include, but not limited to, a filtration unit and a centrifugation unit.

In various embodiments, a calcination unit which may be operated in the temperature range from 150° C. to 400° C. may further be comprised in the integrated system. Examples of calcination unit include, but are not limited to, ovens and furnaces.

Various embodiments refer in a third aspect to use of the method according to the first aspect or the integrated system according to the second aspect in one or more of treatment of water, ambient air, and flue gas, and carbon dioxide recovery. As disclosed herein, various embodiments aim to capture carbon dioxide in an economically viable manner, thus benefitting end users and the planet.

In order that the invention may be readily understood and put into practical effect, particular embodiments will now be described by way of the following non-limiting examples.

### EXAMPLES

### Example A: Alternate Cycles of Carbonization and Decarbonization

As disclosed herein, methods according to embodiments may comprise alternate cycles of carbonization and decarbonization steps, wherein the carbonization steps increase concentration of carbon content in the absorbent and decarbonization steps decrease concentration of carbon content in the absorbent. This may allow the absorbent to be processed in both a carbon-rich as well as a carbon-deficient state, to enable precipitation of different segregated compounds economically and with industrial applicability, without negatively impacting end-to-end carbon capture ratio. Furthermore, thermal energy may be re-used across multiple complementing steps within the disclosed methods, to substantially enhance energy efficiency of the methods. Energy and water may be efficiently recycled using methods disclosed herein, which may otherwise consume so much energy and water that method of capturing carbon becomes uneconomical.

Some novelty points of presently disclosed method and how it significantly reduces infrastructure size: In normal carbon capture system, the flue gas is first scrubbed in a desulphuriser (where SOx is captured) and then it is scrubbed to capture carbon (where CO₂ is captured) since the presence of sulphur in the flue gas damages the carbon capture plant if the desulphuriser plant is not used. This requires at least 2 sets of scrubbers. In the system as presently disclosed, there may only be one scrubber, where all the gasses such as COx, SOx, NOx may be scrubbed-off in one go. Then the aqueous medium may first be decarbonised and then de-sulphurized and then stripped-off of other salts to recover pure water, which may be recirculated back to the process.

In normal carbon capture, the CO₂ that is captured from air or flue gas may be directly used to make carbonates but this process is very slow and requires large infrastructure because the % of carbon dioxide in air or in flue gas is quite low, also the output carbonate is not pure due to impurities present in air or the flue gas. In a process disclosed herein, pure and high humidity CO₂ gas may be produced and then the pure humid CO₂ gas may be used in a third cycle of carbonisation-decarbonisation so the speed of the reaction may be very high and the output carbonate may be very pure.

The recycled water in the normal carbon capture system may contain insoluble carbonates like calcium carbonate which may cause scaling and hence strain the infrastructure, but in this process the recycled water may be distilled water, which may be free from such scaling causing minerals. Also distilled water capture CO₂ from air at a very high speed in the first carbonisation step, and hence speeds up the direct capture of carbon dioxide from air.

### Carbonization and Decarbonization Processes

First Carbonization: The water may be alkalized to a pH of at least 11.5 to convert the dissolved carbon dioxide and the dissolved bicarbonate ions into carbonate ions in the aqueous medium. The aqueous medium may be in contact with ambient air or biogas during this process and hence some additional carbon dioxide from the ambient air or biogas may also dissolve and form carbonate ions in the aqueous medium. This may form carbon-rich aqueous medium.

First Decarbonization: The carbonate rich water may then be treated with alkaline earth cations such as calcium to precipitate insoluble carbonate compounds. This may form carbon-deficient aqueous medium. Most of the excess calcium hydroxide that remains dissolved in the aqueous medium may capture CO₂ from air or biogas till pH drops below 10 and less than 0.1 milli mole per liter excess calcium hydroxide remains in the aqueous medium. The hydration of the cations such as adding calcium or calcium oxide to water may generate lots of heat, which may be utilized to pre-heat the insoluble hydroxide-carbonate precipitate produced in second decarbonization step thus reducing its hydroxide content substantially.

Second Carbonization: The carbon-deficient aqueous medium may then be alkalized and contacted with the flue gas or the smokestack, in single stage or multi-stage contactor arrangement, including potential misting of the alkaline aqueous medium into the flue gas pipe before the flue gas reaches the contactor, to absorb the various constituent acidic gases such as carbon dioxide, various sulfur oxides, various nitrous oxides, etc. contained in the flu gas or the smokestack. This may form a carbon-rich aqueous medium of pH less than 11.0 thus minimizing the excess hydroxide ions in the aqueous medium thereby minimizing the hydroxide content of the mixed-hydroxide-carbonate precipitate formed in the second decarbonization step.

Second Decarbonization: The carbon rich aqueous medium may then be treated with cations that form insoluble carbonates but do not form insoluble sulfates, such as Zinc Chloride or Zinc Sulphate. Thus, only the carbonate ions may be precipitated out of the aqueous medium while the sulfate ions and nitrate ions may remain dissolved in the aqueous medium. Some CO₂ gas may also be released, which may be redirected to the third carbonization step. This may form carbon-deficient aqueous medium. The precipitated insoluble carbonate may be a mixed hydroxide-carbonate precipitate. It may be calcined at temperature about 400 Deg C. to form a stream of hot purified CO₂ gas which may be used to pre-bake the precipitated insoluble carbonate up to a temperature of 150-400 Deg C. The residual heat plus the heat of hydration of Calcium/Calcium Oxide from the first decarbonization step may be used to pre-heat the precipitated insoluble carbonate before pre-baking/calcination, thereby improving the percentage composition of Carbonate in the mixed hydroxide-carbonate precipitate. Subsequently the carbon-deficient aqueous medium may be treated with cations that form insoluble sulfates.

Third Carbonization: The carbon-deficient and sulphate-deficient aqueous medium may then alkalized and exposed to ambient air to capture carbon from the air, or the purified CO₂ from earlier steps, or treated with the soluble aqueous carbonates formed from the earlier steps, to form a carbonate rich aqueous medium which may remain a sulphate-deficient medium.

Third Decarbonization: The aqueous medium may be treated with cations that form insoluble carbonates and insoluble sulfates however since the medium may be sulphate-deficient only the carbonate precipitates are formed, after which the aqueous medium may now be carbonate deficient as well as sulphate deficient.

Methods in this Example A may be exemplified by the following clauses 1 to 18.

Clause 1: The process comprising multiple cycles of carbonization and decarbonization of aqueous medium enabling the processing of the aqueous medium alternately in carbon rich states and carbon deficient states, combined with specifically designed sequence of adding cations and anions in the aqueous medium either via treatment with salts or via exposure to air or target gas, along with extraction of precipitates from the aqueous medium at each step, where part of the precipitate containing insoluble mixed hydroxide-carbonate, formed during the second decarbonization step, is heated to temperature range of 150-400 Deg C. to release hot outputs (steam and CO₂ gas and high purity oxide), part of this thermal energy being sourced from the first carbonization-decarbonization cycle, and part of the thermal energy of the outputs being used to regenerate the aqueous medium or for the pre-baking of the hydroxide-carbonate precipitate.

Clause 2: The process of clause 1, where the aqueous medium is first pre-treated by acidifying it to reduce pH below 4.0 and then alkalizing it to increase pH above 10.5, along with extraction of the CO₂ gas and the precipitates that are generated during the pre-treatment, before the aqueous medium is subjected to the process of alternate cycles of carbonization and decarbonization.

Clause 3: The process of clause 1, where the heat from hot steam and CO₂ gas mixture produced in the second decarbonization step is used to pre-bake the insoluble hydroxide-carbonate precipitate formed during the second decarbonization step, in the temperature range of 150-400 Deg C., and the mixture of steam and CO₂ released in this stage may be channeled separately, or channeled into the calcination step to combine with the CO₂ produced in that step.

Clause 4: The process of clauses 1 to 3, where the heat generated during the first decarbonization step, and the residual heat from pre-baking in the second decarbonization step, is used to pre-heat the insoluble hydroxide-carbonate precipitate produced in second decarbonization step, before it is pre-baked. The hot steam released at this stage may be channeled separately or may be channeled into the pre-baking step and/or calcination step to combine with the CO₂ produced in those steps respectively.

Clause 5: The process of clauses 1 to 4, where the heat of condensation of water vapor and the residual heat from the process is used to generate freshwater from the post-treatment of the decarbonized and desulphurized aqueous medium produced from second decarbonization step or from the third decarbonization step.

Clause 6: The process of clauses 1 to 5, wherein the decarbonized and desulphurized aqueous medium from second decarbonization step or from the third decarbonization step, is first filtered using reverse osmosis process, and the resulting brine is used to generate freshwater from the residual thermal energy from the process.

Clause 7: The process of clauses 1 to 6, where, in the first carbonization step, the input aqueous medium is alkalized to a pH of at least 11.5, in contact with ambient air or target gas, to form carbon-rich aqueous medium.

Clause 8: The process of clauses 1 to 7, wherein in the first decarbonization step, the carbon rich aqueous medium is then treated with alkaline earth cations, such as calcium, to precipitate insoluble carbonate precipitate, to form carbon-deficient aqueous medium, in presence of ambient air or target gas, till pH drops below 10 and less than 0.1 milli mole per liter of excess hydroxide ions remain dissolved in the carbon-deficient aqueous medium.

Clause 9: The process of clauses 1 to 8, where, in the second carbonization step, the carbon-deficient aqueous medium is alkalized and contacted with the flue gas or the smokestack, in single stage or multi-stage contactor arrangement, to absorb the various constituent acidic gases contained in the flue gas or the smokestack to form a carbon-rich aqueous medium.

Clause 10: The process of clauses 1 to 9, where, in the second decarbonization step, the carbon-rich aqueous medium is then treated with cations that form insoluble carbonates but do not form insoluble sulfates, such as Zinc Chloride or Zinc Sulphate, to form carbon-deficient aqueous medium. The precipitated insoluble carbonate is a hydroxide-carbonate precipitate.

Clause 11: The process of clauses 1 to 10, where the hydroxide-carbonate precipitate from the second decarbonization is calcined, or pre-baked, or pre-heated, or any combination thereof, to release steam, or CO₂ gas, or a mixture of steam and CO₂ gas.

Clause 12: The process of clauses 1 to 11, where the carbon-deficient but sulphate-rich aqueous medium from the second decarbonization step is treated with cations that form insoluble sulphate.

Clause 13: The process of clauses 1 to 12, where, in the third carbonization step, the carbon-deficient and sulphate-deficient aqueous medium is alkalized and exposed to ambient air to capture carbon from the air, or the purified CO₂ from earlier steps, or sulphur-free target gas, or treated with the soluble aqueous carbonates, to form a carbonate-rich aqueous medium which remains a sulphate-deficient medium, and precipitates, if any are formed, are removed.

Clause 14: The process of clauses 1 to 13, where, in the third decarbonization step, the carbon-rich but sulphate-deficient aqueous medium is treated with cations that form both insoluble carbonates and insoluble sulfates, to form carbon-deficient and sulphate-deficient aqueous medium and to form high purity carbonate precipitate.

Clause 15: The process of clauses 1 to 14, where the CO₂ gas evolved, or the precipitates forms are extracted and either reused within the process steps or used for alternate purposes.

Clause 16: The process of clauses 1 to 15, where the aqueous medium is water, and where the target gas is a flue gas from a combustion chamber or biogas with high concentration of carbon dioxide.

Clause 17: The reaction chambers, the pre-heating, pre-baking, and the calcination apparatus to run the process consisting of multiple cycles of carbonization and decarbonization of aqueous medium enabling the processing of the aqueous medium alternately in carbon rich states and carbon deficient states, combined with specifically designed sequence of adding cations and anions in the aqueous medium either via treatment with salts or via exposure to air or flu gas or smokestack, along with extraction of precipitates from the aqueous medium at each step, where part of the precipitate containing insoluble mixed hydroxide-carbonate, formed during the second decarbonization step, is heated to temperature range of 150 to 400° C. to release stream and CO₂ gas

Clause 18: Further embodiment of the process, where thermal energy from the first or the second or third cycle of carbonization-decarbonisation is transferred across one cycle to another where one cycle acts are source of heat and other cycle acts as heat sink.

### Example B: Method of Capturing CO₂ and SO₂ from an Input Gas Stream

Also disclosed herein is an integrated method of capturing CO₂ and SO₂ from an input gas stream obtained at or above atmospheric pressure and at or above ambient temperature comprising one or more sources of CO₂ and SO₂ such as air, industrial exhausts (like flue gas or recirculation gas) or concentrated CO₂ gas, wherein the partial pressure of CO₂ is at least the same as in the partial pressure of CO₂ in the ambient atmosphere, by using aqueous solutions (pH 13.5) of soluble hydroxides of alkali metals such as sodium or potassium, along with calcination carried out in humid CO₂ atmosphere at a temperature between 150-400° C. to produce
a. decarbonised and desulfurised output gas stream at or above atmospheric pressure and at or above ambient wet bulb temperature wherein the concentration of CO₂ and SO₂ in the output gas stream is less than the higher of
   i. 33% of the concentration in the ambient atmosphere or
   ii. 10% of the concentration of CO₂ and SO₂ in the input gas stream, where CO₂ concentration in the input gas stream is at least 3.3 times the CO₂ concentration in ambient air
b. decarbonised and desulfurised output water stream at or above atmospheric pressure and at or above ambient wet bulb temperature wherein the dissolved carbonate alkalinity other than carbonate salts of alkali metals such as sodium or potassium is less than 1 gram per litre and the dissolved sulphate salts other than the sulphate salts of alkali metals such as sodium or potassium is less than 1 gram per litre
c. high purity salts including carbonates, bicarbonates, sulphates, and chlorides of alkali metals such as sodium or potassium; carbonate and oxide of Zinc; carbonate and sulphate of strontium, each with at least 90% purity,
d. high purity humid CO₂ of at least 90% purity at or above atmospheric pressure and at or above ambient temperature
e. pure water, softened water, alkaline water, carbonated/soda water, carbonic acid

| | | 33% CO₂ | 10% CO₂ OF THE | |
|---|---|---|---|---|
| | | OF THE | INPUT GAS | HIGHER |
| SOURCE | CO₂ | AIR | STREAM | THRESHOLD |
| AIR | 400 ppm | 133 ppm | 40 ppm | 33% CO₂ of the air |
| INDUSTRIAL | 1000 ppm | 133 ppm | 100 ppm | 33% CO₂ of the air |
| SOURCE | | | | |
| INDUSTRIAL | 1333 ppm | 133 ppm | 133 ppm | Both are same |
| SOURCE | | | | |
| INDUSTRIAL | 2000 ppm | 133 ppm | 200 ppm | 10% CO₂ of the |
| SOURCE | | | | input stream |

The method may include using alternating cycles of
carbonisation stage to add some aqueous carbonate ions to a water solution,
   wherein CO₂ is captured from a source of CO₂ and the captured CO₂ is used to form some aqueous carbonate ions, or the dissolved aqueous CO₂ and the dissolved aqueous bicarbonate ions are converted to some aqueous carbonate ions, or additional high purity soluble carbonate salts produced within the disclosed method are admixed with water to add aqueous carbonate ions, thereby adding enough moles of the aqueous carbonate ions in the water solution as needed in the subsequent decarbonisation stage;
decarbonisation stage to remove aqueous carbonate ions from a water solution,
   wherein the aqueous carbonate ions are admixed with aqueous cations to precipitate insoluble carbonates, either using the cations which are pre-existing in the water solution or using cations that are specifically added to the water solution, such that the dissolved carbonate alkalinity other than carbonate salts of alkali metals is reduced to less than 1 gram per litre, thereby removing majority the carbonate ions from the water.

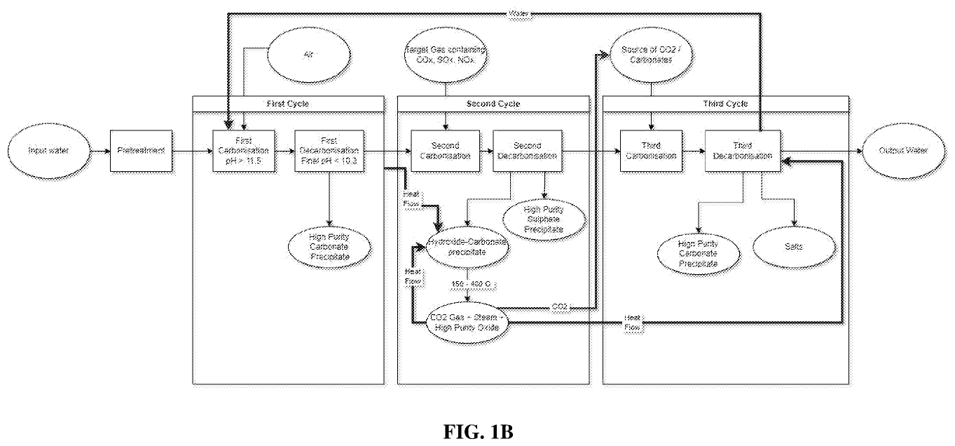

The alternating cycles may include the water flowing through a specific sequence of stages described hereunder and as shown in FIG. 2.
1. first water-carbonisation stage;
2. first water-decarbonisation stage;
3. second water-carbonisation stage;
4. water-sulfurization stage;
5. second water-decarbonisation stage;
6. water-desulfurization stage;
7. third water-carbonisation stage;
8. third water-decarbonisation stage;
9. water stream post-processing stage
10. air/gas stream post-processing stage.

| Stage | Objective - gas stream | Objective - water stream |
|---|---|---|
| First water | Remove water-soluble caustic | Increase bicarbonate and carbonate |
| carbonisation | fumes like hydroxides and | ions in water up to the saturation level |
| | carbonates of sodium and | of insoluble carbonate/bicarbonate |
| | potassium from the gas stream. | salts |
| | Also, remove some more of the | |
| | water-soluble acidic gasses like | |
| | CO₂ and SO₂ from the gas | |
| | stream. | |
| First water | NA | Obtain precipitate of water-insoluble |
| decarbonisation | | salts of carbonates and/or hydroxides |
| | | Also, obtain soft water. |
| Second water | Remove water-soluble acidic | Increase bicarbonate and carbonate |
| carbonisation | gasses like CO₂ and SO₂ from | ions in water up to the saturation level |
| | the gas stream | of insoluble carbonate/bicarbonate |
| | | salts, and some precipitates due to |
| | | over concentration |
| Second water | NA | Obtain high purity precipitate of |
| decarbonisation | | water-insoluble hydroxide-carbonate |
| | | salt |
| | | Also, obtain oxide salt and humid-CO₂ |
| | | gas |
| Third water | NA | Increase carbonate ion concentration |
| carbonisation | | up to saturation level in desulfurised |
| | | water. Obtain high purity precipitate |
| | | of water-soluble salts of carbonate |
| | | and/or bicarbonate |
| Third water | NA | Obtain high purity precipitate of |
| decarbonisation | | water-insoluble carbonate salt |
| | | (without impurity of water-insoluble |
| | | sulphate salt) |
| Water | Remove water-soluble acidic | Increase sulphate ion concentration in |
| sulfurisation | gasses like SO₂, where the input | water |
| | gas stream has more than 100 | |
| | times the SO₂ concentration of | |
| | air. | |
| Water | NA | Obtain high purity precipitate of |
| desulphurisation | | water-insoluble salts of sulphate ion |
| | | (without impurity of water-insoluble |
| | | carbonate salt |
| Water post- | | Obtain pure water, obtain water- |
| processing | | soluble chloride salts, obtain |
| | | hydroxide |
| Air post- | Recover Nitrogen gas and pure | NA |
| processing | water from the output gas | |
| | stream | |

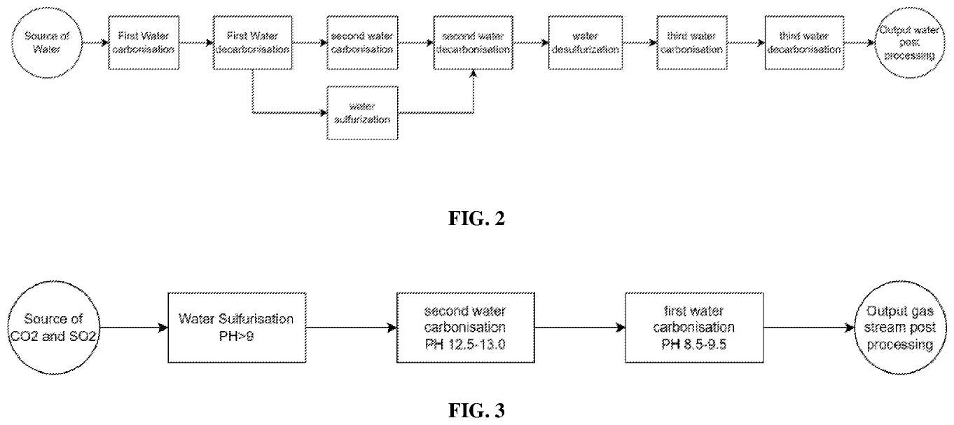

The method may further include flowing the source of CO₂ and SO₂ through a specific sequence of stages as described hereunder and as shown in FIG. 3.
A. the water-sulfurization stage;
B. the second water-carbonisation stage;
C. the first water-carbonisation stage; and
D. the output of gas stream post-processing stage.

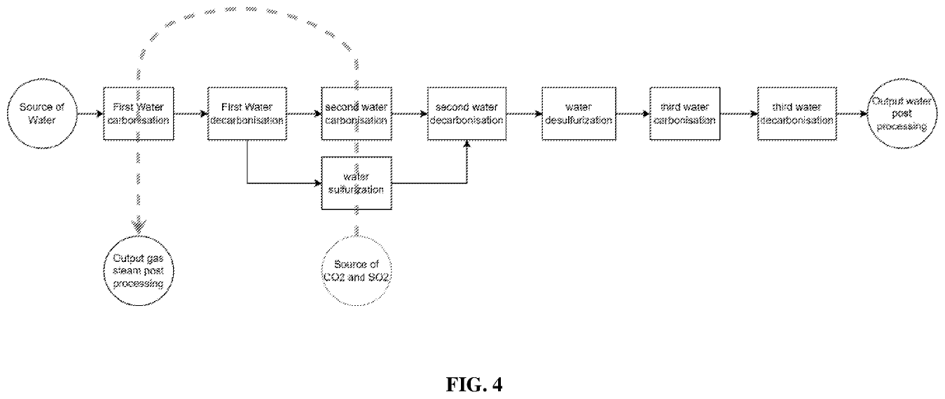

FIG. 4 shows the exchange between the water flow diagram in FIG. 2 and the gas flow diagram in FIG. 3.

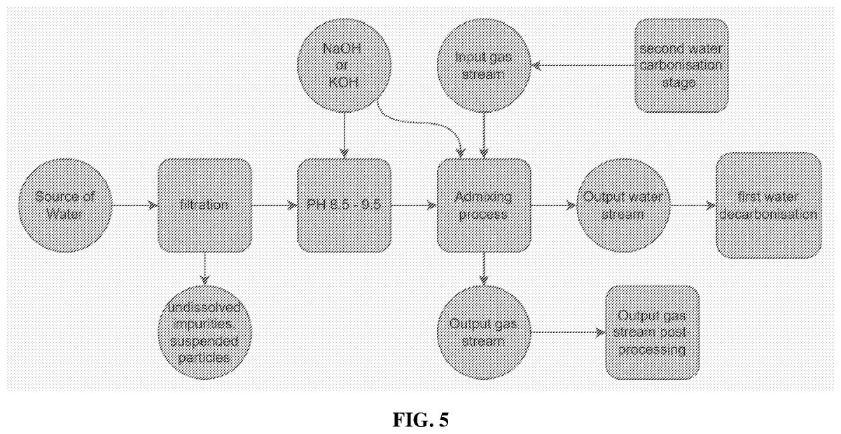

### 1) First Water-Carbonisation Stage (See FIG. 5)

The input water may be from natural sources or industrial sources
i. If the input water contains any undissolved impurities or suspended particles, the input water may be filtered to remove undissolved suspended particles
ii. If the input water contains any dissolved CO₂ or the input water has been exposed to the atmosphere such that some CO₂ gas has been dissolved in the input water, and if the input water is at PH<8.4, sodium hydroxide or potassium hydroxide may be added to raise PH to PH8.5-9.5
   a. All the dissolved CO₂ may be converted to bicarbonate ions. Thus, when the input gas stream is admixed with this water solution, the gas stream may not pick up any additional CO₂ from the water.
   b. Some bicarbonate ions may be converted to carbonate ions. If the input water stream contains cation such as calcium or magnesium that form insoluble carbonate salts of solubility less than 1 gram/litre, some carbonate precipitate may precipitate out of the water solution.

Admix the input gas stream with this water solution along with agitation to enable precipitates to flow along with water.
i. The input gas stream may be the output gas stream from the second water-carbonisation stage
   a. If the input gas stream contains any high-PH corrosive carry over droplets from the previous stage, these may be captured and the dose required for the sodium hydroxide or potassium hydroxide needed to maintain PH8.5-9.9 may be reduced.
ii. If the input gas stream contains CO₂ and SO₂ at higher partial pressure than the partial pressure of CO₂ and SO₂ of this water solution, some CO₂ and SO₂ may be captured. This may increase the carbonate ion concentration and the sulphite/bisulphite ion concentration in the water solution
   a. If the input water stream contains cation such as calcium or magnesium that form insoluble carbonate salts with solubility less than 1 gram/litre, some carbonate precipitate may precipitate out of the water solution.
iii. The output gas stream may be decarbonised and desulfurised, wherein the concentration of CO₂ and SO₂ in the output gas stream may be less than the higher of (a) 33% of the concentration in the ambient atmosphere or (b) 10% of the concentration of CO₂ and SO₂ in the input gas stream where the CO₂ concentration may be at least 3.3 times that in ambient air. The output gas stream may also be highly humidified at or above ambient wet bulb temperature and at or above atmospheric pressure.
iv. The output gas stream may contain some carry over droplets
   a. Since the water solution used in this stage may be in the PH8.5-9.5 range, the carryover droplets may be non-corrosive.
   b. The output gas stream may be exhausted into the air or may undergo a post-processing stage.
v. The output water stream may be the input water stream for the first water-decarbonisation stage
   a. If any carbonate precipitates are formed, these may be carried along with water into the first water-decarbonisation stage
vi. The input gas stream may be admixed with this water solution along with agitation to enable precipitates to flow along with water.

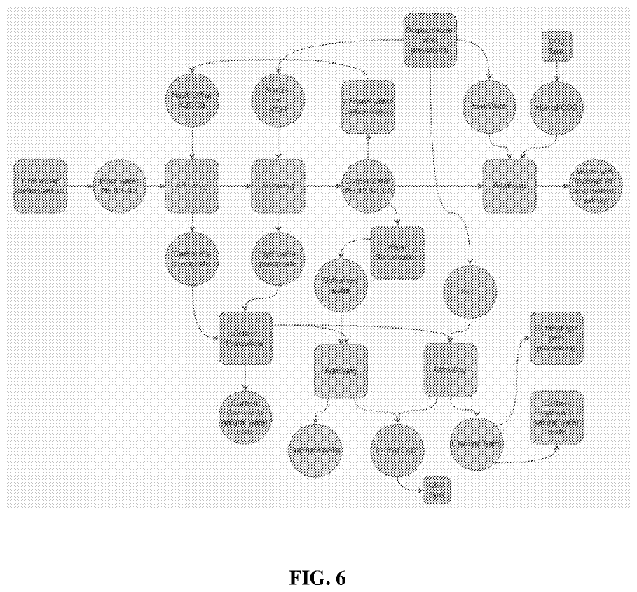

### 2) First Water-Decarbonisation Stage (See FIG. 6)

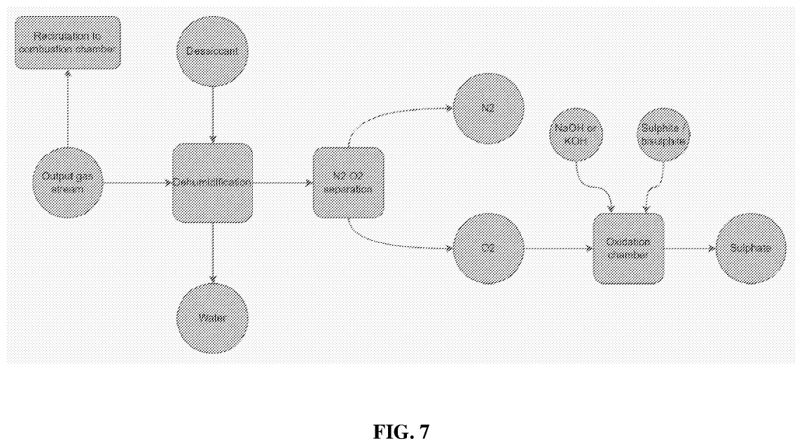

a. The input water may be the output water at PH8.5-9.5 from the first water-carbonisation stage.
b. If the input water contains aqueous cations such as calcium and magnesium that form insoluble carbonates with solubility less than 1 gram per litre, then sodium carbonate or potassium carbonate may be added, which may be produced in the second water-carbonisation stage, to form insoluble carbonate precipitates leaving behind less than 1 gram per litre of dissolved carbonates of such cations
   i. For the first cycle where sodium or potassium carbonate has not been produced in the water-carbonisation stage, externally sourced sodium or potassium carbonate may be used in this step.
   ii. Since the input water PH may be 8.5-9.5, the added carbonate ions may be stable and do not decompose to bicarbonate ions
   iii. Sodium or potassium carbonate in 0-5% excess of the stoichiometric ratio may be added to ensure complete precipitation of all the insoluble carbonate salts with solubility less than 1 gram/litre.
c. After the carbonate precipitation is complete, sodium hydroxide or potassium hydroxide may be added to raise PH to PH12.5-13.0.
   i. If any aqueous bicarbonate ions are present, these may be converted to aqueous carbonate ions.
   ii. If any cations such as magnesium are present, where the hydroxide salt is less soluble than the carbonate salt, then hydroxide precipitates of such cations may be formed.
d. The water may now be alkaline at PH12.5-13.0 and substantially free from cations like calcium and magnesium, which form insoluble carbonates and hydroxides.
   i. This may be the output water from the first water-decarbonisation stage. It may contain carbonate alkalinity of less than 1 gram/litre other than the carbonates of cations like sodium or potassium that form soluble carbonates.
   ii. The water may contain some soluble carbonates and hydroxides of aqueous cations present in water, such as sodium or potassium, that form soluble carbonates and hydroxides.
   iii. This output water may be the input water for the second water-carbonisation stage and the water-sulfurization stages
e. Alkaline water management
   i. Some of this alkaline water at PH12.5-13.0 may be admixed at a pressure higher than atmospheric pressure with the pure humid CO₂ produced in various stages in this method to reduce the PH to the desired level, thus producing alkaline water at PH7.0-12.0, soft neutral water at PH˜7.0, or carbonated water/soda water at PH<7.0 and may also be admixed with the pure water produced in the output gas post-processing stage and output water post-processing stage, to dilute the salt concentration to the desired level.
f. Precipitate management
   i. Some or all these precipitates of insoluble carbonates and hydroxides may be added back to natural water bodies, especially in waters unsaturated with carbonate, or upwelling deep waters, to slowly capture additional CO₂ from the environment and neutralize the unwanted acidification caused due to increase in atmospheric CO₂ concentration thus supporting marine ecosystems.
   ii. Some or all these precipitates of insoluble carbonates and hydroxides may be treated with hydrochloric acid produced in the output water post-processing stage of this method to release high purity CO₂ gas stream and to convert these carbonate precipitates into chloride salts, which may be used in the solid or liquid desiccant in the output gas post-processing stage, and maybe added back to natural water bodies, especially in natural water bodies to slowly capture additional CO₂ from the environment, especially in water bodies oversaturated with carbonate ions iii. Some or all these precipitates of insoluble carbonates and hydroxides may be treated with sulphite/sulphate solution produced in the water sulfurization stage of this method to release high purity CO₂ gas stream and to convert these carbonate precipitates into sulphite or sulphate salts.
      2A) A stage of post-processing the decarbonised desulfurised and highly humidified output gas stream from the first water-carbonisation stage may be provided (See FIG. 7).
a. Output gas management
   i. The output gas stream may be used as the recirculation gas stream for the industrial combustion processes to reduce NOx generation and enable efficient combustion at partial loads; or may be let out into the atmosphere.
b. Humidity Extraction
   ii. The output gas may be dehumidified using the solid or liquid desiccant, part of which may be produced within this method. Pure water may be thermally liberated from the hydrated desiccant using the heat source within this method, including the exothermic heat from various admixing steps or the heat from hot products from the second water-decarbonation stage. Some pure water may be admixed with the pure humid CO₂ produced within this method to produce carbonic acid or soda water.
c. Nitrogen and Oxygen Extraction
   iii. Where the source of CO₂ and SO₂ used in this method is an industrial combustion exhaust wherein the concentration of O₂ in the output gas stream produced by the first carbonisation stage is lower than the concentration of O₂ in the ambient air, this output gas stream may be further processed after dehumidification, to separate N₂ and O₂ such as by using Pressure Swing Adsorption, to obtain high purity gas streams of N₂ and O₂ more economically than generating a gas stream of N₂ from the ambient air since the output gas stream is already filtered off from suspended impurities, already filtered off from CO₂ and SO₂, and may already be dehumidified, and already contains less O₂ than ambient air, thus may need less energy to separate N₂ and O₂
   iv. Where the SO₂ concentration in the source of CO₂ and SO₂ used in the method is higher than the SO₂ concentration in the ambient air, part of the O₂ contained in the source of CO₂ and SO₂ may be scavenged by the aqueous sulphite/bisulphite ions produced by SO₂ captured in this method, thus producing an output gas stream from the first water-carbonisation stage with a lower concentration of O₂ than the concentration of O₂ in the source of CO₂ and SO₂ used in the method, thus further enhancing the efficiency of the N₂—O₂ separation process
d. Oxygen management
   i. Part of the high purity O₂ gas stream may be used as the source of O₂ in an enclosed oxidation chamber, at or above atmospheric pressure, with or without Ozonation, for the oxidation of aqueous sulphite/bisulphite produced by capture of SO₂ in this method thus enhancing the oxidation kinetics of aqueous sulphite/bisulphite in this method to form aqueous sulphates/bisulphates. The soluble hydroxide of alkali metals such as sodium or potassium may be admixed with the water solution in this enclosed oxidation chamber in a 0-10% excess of the stoichiometric ratio to convert aqueous bisulphate into aqueous sulphate. The oxidised water solution containing sulphates may be circulated back to the same stage or the respective next stage.
e. Nitrogen Management
   i. Some of the high purity N₂ may be used to provide an inert environment for storing and packaging the products of the method or may be combined with some of the H₂ produced in the method to make Ammonia, part of which may be used for denitrification in selective catalyst reduction of the source of CO₂ and SO₂ if this source contains more than 100 mg/M³ of NOx before this source of CO₂ and SO₂ is used as the input gas stream in this method. Thus, any excess unreacted Ammonia present in the input gas stream may be dissolved in water solution during the SO₂ and CO₂ capture stages, thus preventing the emission of unreacted Ammonia into the atmosphere.

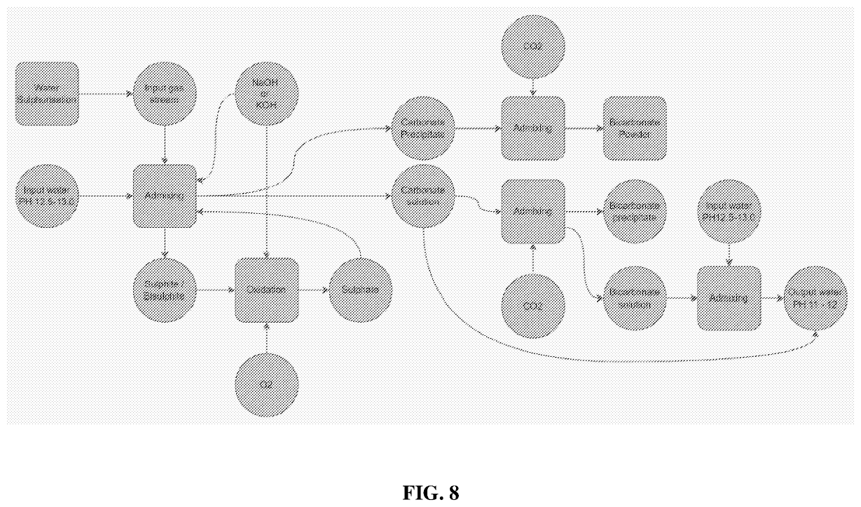

### 3) Second Water-Carbonisation Stage (See FIG. 8)

The alkaline water at PH 12.5-13.0 obtained from the first water-decarbonisation stage may be carbonised by admixing it with the input gas stream and admixing it incrementally with the soluble hydroxide of alkali metals such as sodium or potassium in the stoichiometric ratio to form additional aqueous carbonate ions, which combine with the aqueous cations in water to form soluble carbonates. The input gas stream may be at or above ambient temperature and at or above atmospheric pressure.
a. SO₂ vs CO₂ concentration management
   i. The source of CO₂ and SO₂ may be used as the input gas stream for the second water-carbonisation stage if the CO₂ concentration is at least 100 times the SO₂ concentration in the input gas stream on a 100-mole basis. However, if the CO₂ concentration is less than 100 times the SO₂ concentration in the source of CO₂ and SO₂ on a 100-mole basis, then the input gas stream may be the output gas stream from the water-sulfurization stage. Thus, the input gas stream used in the second water-carbonisation stage may always contain a concentration of CO₂ which is more than 100 times the concentration of SO₂ on a 100-mole basis
b. SO₂ and CO₂ capture
   i. The CO₂ and SO₂ in the input gas stream may be captured into the alkaline solution, and the captured CO₂ may form carbonate ions while the captured SO₂ forms sulphite ions or bisulphite ions. Simultaneously, part of the water solution may be sent to the enclosed oxidation chamber, where it may be admixed with O₂ in the presence of aqueous hydroxide to convert the sulphite or bisulphite ions into sulphate ions. This sulphate solution may be circulated back to the water solution in this second water-carbonisation stage. Moreover, this sulphate rich water returning to the second water-carbonisation stage may be rich in dissolved oxygen which further oxidises the sulphite/bisulphite into sulphate/bisulphate ions, after which the bisulphate ions combine with the aqueous hydroxide ions present in the water solution to form sulphate ions, due to the PH of the water solution being maintained in the PH12.5-13.0 range by sufficient addition of sodium or potassium hydroxide. This oxidation process may be repeatedly performed to convert more and more of the sulphite/bisulphite ions to sulphate ions.
c. Maintain purity of carbonate precipitate
   i. The admixing process may be continued until 90% of the solubility threshold of any of the sulphate salts of alkali metals such as sodium or potassium is exceeded. The crystallisation and precipitation of these sulphate salts may be prevented. Part of the solution may be bled out to the second water-decarbonisation stage, and the level of water in this second water-carbonisation stage may be topped up with input water used in this second water-carbonisation stage to ensure the concentration of the sulphates of alkali metals remains below 90% of their solubility threshold at the given temperature and pressure.
   ii. The solubility curve of carbonate salts of alkali metals such as sodium and potassium may be similar to the solubility of the sulphate salts of the alkali metals such as sodium or potassium. However, the CO₂ concentration may be at least 100 times higher than the concentration of the SO₂ in the input gas stream used in this admixing process; hence the carbonate salts may crystallise and precipitate out of the water solution before the sulphate salt concentration reaches 90% of their solubility threshold, thus producing high purity precipitate of carbonate.
d. Temperature Management
   i. Where the input gas stream used in the method has a wet-bulb temperature below 40 Degree Celsius, this admixing process may be performed preferably in a controlled temperature range of 36-48 Degree Celsius (as the optimum compromise temperature range considering decreasing solubility of CO₂ in water with increasing temperature, highest solubility vs temperature profile for carbonate and sulphate salts of alkali metals, and carbonate monohydrate stability) to obtain high purity precipitates of the excess soluble carbonates in the form of carbonate monohydrate of alkali metals and to produce a 100% saturated solution of soluble carbonate salts and up to 90% saturated solution of salts of ions containing sulphur at PH 11.0-12.0, such that at least 90% of the moles of hydroxide may be used up to form carbonates and sulphates from the CO₂ and SO₂ present in the input gas stream used in this step. This solution containing carbonates and sulphates may be the output water stream from the second carbonisation stage and may be the input water for the second water-decarbonisation stage.
   ii. Where the input gas stream has a wet-bulb temperature greater than 40 degrees Celsius, this admixing process may be performed in the controlled temperature range of 36-99 Degree Celsius. The water solution and the precipitated carbonate monohydrate, which may be in thermal communication, may be cooled down to 36-48 Degree Celsius before extracting the precipitated carbonate monohydrate and using the leftover water solution at PH 11.0-12.0 may be used as the input water for the second water-decarbonisation stage.
e. Conversion of Carbonate precipitate to Bicarbonate
   i. The carbonate monohydrate precipitate produced in this stage may be ground into a fine powder. The molar ratio of free water to carbonate monohydrate in the precipitate may be maintained between 1.4:1 to 1.8:1 at 36-48 degrees Celsius.
      a. If the molar ratio of free water to carbonate monohydrate is less than 1.4:1, then high purity water containing less than 350 parts per million of total dissolved solids may be added to the finely ground precipitate. Some or all this water may be produced in this disclosed method.
      b. If the molar ratio of free water to carbonate monohydrate is greater than 1.8:1, then the finely ground precipitate may be dried to remove excess moisture using the heat sources in the disclosed method, including the exothermic heat produced in the disclosed method or the hot Zinc Oxide or the hot CO₂ or the waste heat from the industrial exhaust.
   ii. This moisture-controlled precipitate powder may be admixed with the concentrated humid CO₂, at or above ambient atmospheric pressure, produced within this method in the second water-decarbonisation stage. It may be supplemented with externally sourced concentrated CO₂. The moisture-controlled precipitate may also be first admixed with the output gas stream of the second water-carbonisation stage at or above ambient atmospheric pressure before it enters the first water-carbonisation stage, and then separately additionally admixed with the concentrated CO₂. The temperature may preferably be maintained in the range of 36-48 Degree Celsius. Thus, high purity bicarbonate may be produced.
f. Conversion of dissolved carbonate to bicarbonate
   i. Part of the output water solution second water-carbonisation stage, saturated with soluble carbonates, may be used to obtain more bicarbonate precipitate before being used as the input water in the second water-decarbonisation stage by admixing it with the concentrated humid CO₂ at or above ambient atmospheric pressure. This concentrated humid CO₂ may be produced within this method in the second water-decarbonisation stage and may be supplemented with externally sourced concentrated CO₂. The saturated solution of soluble carbonates may also be first admixed with the output gas stream of the second water-carbonisation stage at or above atmospheric pressure before it enters the first water-carbonisation stage, and then separately additionally admixed with the concentrated CO₂. The temperature may preferably be maintained in the range of 36-48 Degree Celsius. Thus, high purity bicarbonate may precipitate and a saturated bicarbonate solution may be produced. This saturated solution of soluble bicarbonate may contain a high concentration of soluble sulphate. This solution may be admixed with the alkaline water obtained from the first water-decarbonisation stage in a stoichiometric ratio. At least 90% of the moles of hydroxide may be used to convert all the dissolved bicarbonates into carbonates and any dissolved bisulphates into dissolved sulphates. This solution may be at PH11-12.0 and contains carbonates and sulphates. This may be the output water stream from the second water-carbonisation stage and may be the input water for the second water-decarbonisation stage.

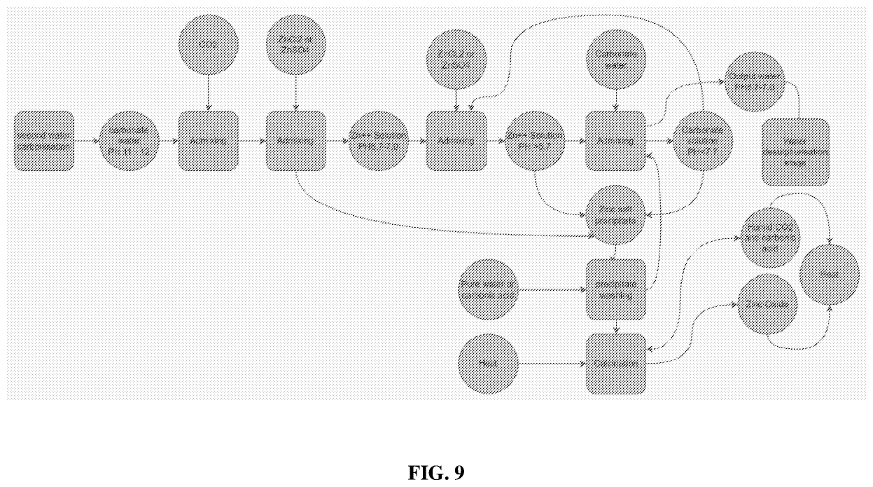

### 4) Second Water-Decarbonisation Stage (See FIG. 9)

The input water may be decarbonised as follows—
a. Preparation of process solution
   i. the output water from the first water-decarbonisation stage and the output water from the second water-carbonisation stage may be received in an enclosed reaction chamber, preferably in the temperature range of 36-48 Degree Celsius, and
   ii. a concentrated CO₂ atmosphere at or above the ambient pressure may be maintained inside the enclosed reaction chamber such that the PH of the water drops below PH12.0 but not below PH7.0.
   iii. this water at PH 7.0-12.0 may be admixed with Zinc Chloride or Zinc Sulphate, in salt form or an aqueous form, along with rotation or stirring of the mixture to create a near-uniform concentration of dissolved salts and near-uniform PH across the entire volume of the water solution.
   iv. Thus, the Zinc ions may combine with aqueous hydroxide ions and aqueous carbonate ions to form precipitates of Zinc Hydroxide, Zinc Hydroxycarbonate, or Zinc Carbonate.
   v. Zinc Chloride or Zinc Sulphate may be added until when the PH of the water solution adjusts to a near-neutral range of PH 6.7-7.0.
   vi. Most of the aqueous hydroxide ions, aqueous carbonate ions and aqueous zinc ions may be precipitated out of the solution leaving behind less than 0.1 molar concentration of each of these ions in the water solution.
   vii. Zinc Sulphate may be used only to the extent of not exceeding the solubility limit of sulphate salts contained in the water solution.
b. Decarbonisation process
   i. Now, additional Zinc Chloride or Zinc Sulphate may be added in salt or aqueous solution form. A maximum concentration of 0.1 molarity of aqueous unprecipitated Zinc ions may be maintained, and the PH of the water solution may be maintained above PH5.7. Thus, a precipitate of Zinc Hydroxide, Zinc Hydroxycarbonate, or Zinc Carbonate may be formed, and the excess unprecipitated zinc ions may form a highly diluted solution of aqueous zinc ions
   ii. Then, the concentrated carbonate water solution from the second water-carbonisation stage may be added to the dilute zinc ion solution. A maximum concentration of 0.1 molarity of aqueous unprecipitated carbonate ions is maintained, and a maximum PH7.7 of the water solution is maintained. Thus, a precipitate of Zinc Hydroxide, Zinc Hydroxycarbonate, or Zinc Carbonate may be formed, and the excess unprecipitated carbonate ions may form a highly diluted solution of aqueous carbonate ions.
   iii. These two admixing processes may be repeated alternately to form dilute Zinc ion solution and dilute carbonate ion solution along with continuous rotation or stirring of the mixture to ensure the PH of the entire solution oscillates within the PH5.7-7.7 range, preferably centred around a median of PH 6.7-7.0
   iv. The oscillations may be continued until the desired quantity of precipitate is obtained. This precipitate may consist primarily of Zinc Hydroxide, Zinc Hydroxycarbonate, or Zinc Carbonate.
c. Extraction of output water
   i. The oscillations may be stopped when the concentration of salts other than the salt of zinc exceeds 90% of their solubility thresholds and at a point when the water is at PH6.7-7.0 amidst the mentioned oscillations between PH5.7 and PH7.7 and the water solution may be sent to the next stage of water-desulfurization. In this PH6.7-7.0 range, the concentration of free aqueous carbonate ions and the concentration of aqueous zinc ions may be at the minimum and may contain less than 1 gram per litre of dissolved carbonates other than carbonates of alkali metals such as sodium or potassium.
   ii. Alternatively, a part of the water solution may be bled out during the oscillations when the water is at PH6.7-7.0 amidst the mentioned oscillations between PH5.7 and PH7.7 and the water level may be topped up by soft alkaline water from the first water-decarbonisation stage or the concentrated carbonate ion water solution from the second water-carbonisation stage to make up for any shortfall in the volume of water. This may ensure that the concentration of salts other than the salt of zinc remains below 90% of their solubility threshold. This bleed water may be the output water sent to the stage of water-desulfurization. In this PH6.7-7.0 range, the concentration of free aqueous carbonate ions and the concentration of aqueous zinc ions may be at the minimum and may contain less than 1 gram per litre of dissolved carbonates other than carbonates of alkali metals such as sodium or potassium.
d. Maintenance of CO₂ atmosphere
   i. The entire process of second water-decarbonisation may be carried out preferably in the temperature range of 36-48 Degree Celsius.
   ii. The entire process may preferably be carried out in an enclosed chamber containing an atmosphere of concentrated CO₂ at or above the atmospheric pressure.
   iii. Thus, some CO₂ may dissolve into the water solution and neutralize the excess hydroxide ions, thereby forming additional aqueous carbonate ions.
   iv. Also, some CO₂ may be liberated during the precipitation process due to the formation of zinc hydroxycarbonate.
   v. Accordingly, CO₂ gas may either be added to the precipitation tank or CO₂ gas may be taken out from the enclosed chamber to maintain the pressure inside the enclosed chamber in the range of 1-5 atmospheric pressures.
e. Washing of Precipitate
   i. The precipitate may be washed in pure water containing less than 350 parts per million of total dissolved solids or washed with carbonic acid.
   ii. This pure water or carbonic acid may be produced within the output gas or output water post-processing stage of this method or supplemented from external sources.
   iii. The washing may be carried out in a concentrated CO₂ environment at or above atmospheric pressure to neutralize some of the zinc hydroxide and zinc hydroxycarbonate contents of the precipitate to increase the yield of zinc carbonate and to remove any unreacted carbonate precipitates of alkali metals. Thus, high purity Zinc Carbonate precipitate may be formed.
   iv. This used water left behind after the Zinc Carbonate precipitate is extracted may be reused to wash more precipitate consisting of Zinc Hydroxide, Zinc Hydroxycarbonate, or Zinc Carbonate. The excess water may be admixed into the water solution in the enclosed reaction chamber during the alternating cycles of zinc ion addition and carbonate ion addition.
f. Calcination
   i. The precipitate, rich in Zinc Carbonate, may be thermally decomposed in a concentrated CO₂ environment, maintained either at atmospheric pressure or below or above atmospheric pressure, between 150-400 Degree Celsius, preferably in the range 275-300 Degree Celsius, to form high purity hot Zinc Oxide salt and high purity hot, humid CO₂ gas stream.
   ii. Part of the heat for this thermal decomposition may be obtained from the waste heat from the industrial exhaust or industrial combustion recirculation airflow such as at low loads, or may be obtained from natural sources such as solar or geothermal heat, or may be obtained from the exothermic heat generated within the method, or maybe supplemented with suitably sourced energy such as electricity at low loads
   iii. The heat from the hot Zinc Oxide and the hot CO₂ may be used to maintain the specific temperatures in various stages of the method and liberate fresh water from the hydrated desiccant thermally.
   iv. The humid CO₂ released in this step and other steps in this disclosed method may be stored in a CO₂ tank at or above atmospheric pressure. This CO₂ may be reused as a source of CO₂ or to supplement the source of CO₂ in the water-carbonisation steps in the disclosed method.
   v. Once the heat from the hot, humid CO₂ is used in this method, the hot, humid CO₂ may cool down below the dew point temperature, thereby condensing high purity water in the CO₂ atmosphere leading to the formation of high purity carbonic acid, some of which may be used to wash the Zinc salt precipitate

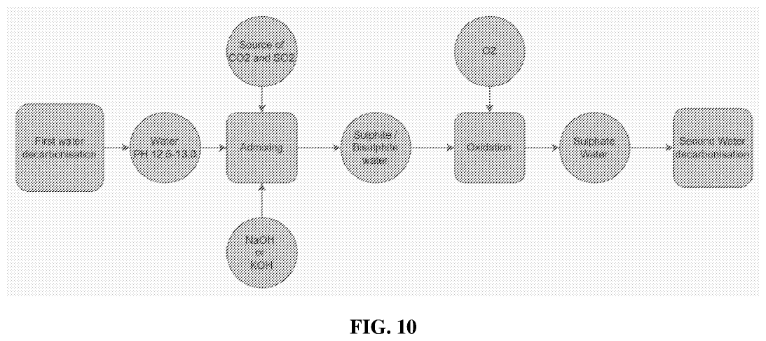

### 5) Water-Sulfurization Stage (See FIG. 10)

The input water may be the output water obtained from the first water-decarbonisation stage. This input water may be sulfurized during this stage, i.e., sufficient moles of aqueous sulphite or sulphate ions are added to the water solution, such that the output water of this stage contains enough dissolved sulphate ions to reach at least 90% of the solubility threshold of the sulphate salts formed with alkali metals ions such as sodium or potassium, and the output water of this stage is the input water for the second water-decarbonisation stage.

If the source of CO₂ and SO₂ has a CO₂ concentration less than 100 times the concentration of SO₂ on a 100-mole basis, then the source of CO₂ and SO₂ may be admixed in an enclosed reaction chamber with the output water from the first water-decarbonisation stage. The input water is at PH12.5-13.0. Additional sodium or potassium hydroxide doses may be added to maintain PH>9.0. The admixing reaction may continue until the concentration of sulphite, bisulphite, sulphate, or bisulphate reaches 90% of the solubility threshold at the given temperature and pressure.

Some of this sulphite/bisulphite rich water may be redirected back to the industrial boiler to scavenge the oxygen and reduce corrosion.

This sulfurized water may be led to an oxidation chamber where it may be admixed with air or oxygen, with or without ozonation, at a pressure between 1-5 bars. Thus, sulphite may be oxidised to sulphate and bisulphite is oxidised to bisulphate. Sodium or potassium hydroxide may be added to the water in the oxidation chamber up to 10% more than the stoichiometric ratio, thus maintaining PH>9.0, so the bisulphate may be converted to sulphate. Thus, sulphate-rich water may be produced. This water may also have some CO₂ dissolved in the form of bicarbonates or carbonates. This forms the input water for the second water-decarbonisation stage.

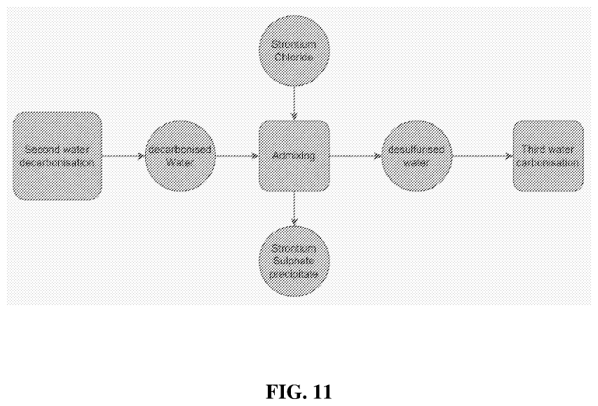

### 6) Water-Desulfurization Stage (See FIG. 11)

The input water may be the decarbonised water obtained from the second water-decarbonisation stage, this input water may be desulfurised during this stage, i.e., sufficient moles of aqueous sulphate ions may be removed from the water solution, such that the output water contains no more than 1 gram/litre of salts of sulphate ions
The input water may be the output water from the second water-decarbonisation stage. This input water may be admixed and stirred with Strontium Chloride.
   a. either in a stoichiometric ratio where a different cation is used in the third decarbonisation stage to precipitate carbonate,
   b. or in slight excess (5-10% excess moles) of the stoichiometric ratio where the same cation is used in the third decarbonisation stage to precipitate carbonate,
This may form a precipitate of Strontium Sulphate, which is insoluble in water, thereby leaving behind less than 1 gram per litre of dissolved sulphates other than sulphates of alkali metals after the Strontium Sulphate has been precipitated.
Some of the insoluble carbonate sediments from the first decarbonisation stage may be admixed with the input water to produce a slurry of the insoluble sulphate salts of the cations which had produced the insoluble carbonates and to release high purity CO₂.

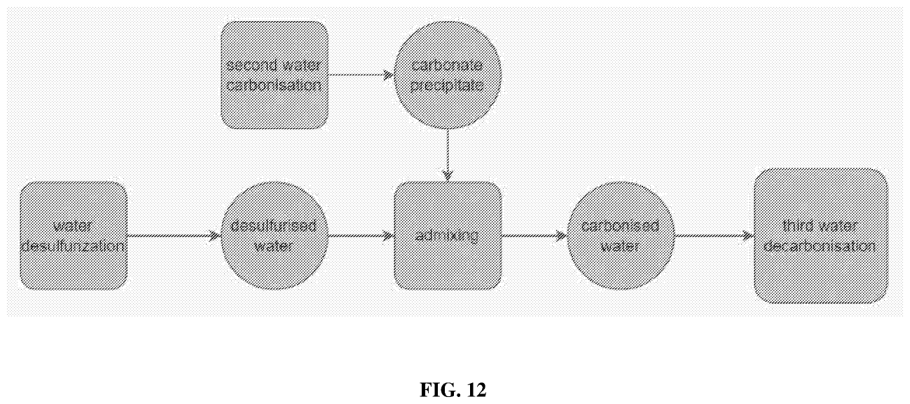

### 7) Third Water-Carbonisation Stage (See FIG. 12)

The input water may be the desulfurised water obtained from the water-desulfurization stage. This input water may be carbonised during this stage, such that the output water of this stage may contain enough aqueous carbonate ions to reach at least 90% of the solubility threshold of the carbonate salts formed with alkali metal ions such as sodium or potassium, and this output water of this stage may be the input water of the third water-carbonisation stage.

The input water may be carbonised by admixing it with the high purity precipitates of alkali metal carbonates produced in the second carbonisation stage to obtain aqueous carbonate anions in the desulfurised water.

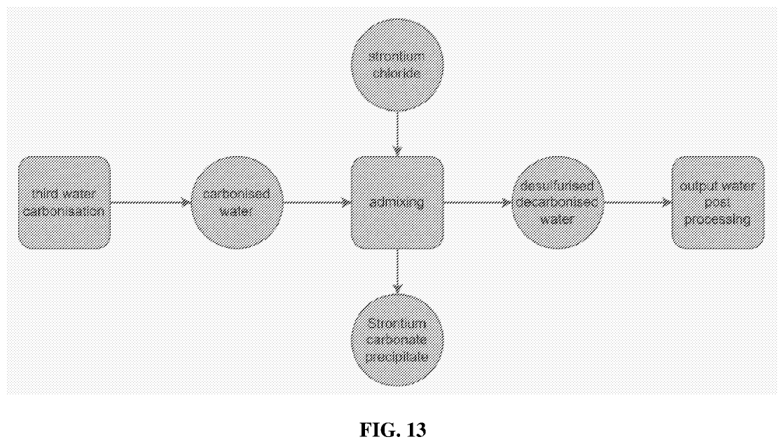

### 8) Third Water-Decarbonisation Stage (See FIG. 13)

The input water may be the carbonised water obtained from the thirst water-carbonisation stage. This input water may be decarbonised during this stage, such that the output water of this stage may contain less than 1 gram/litre of salts of aqueous carbonate ions other than the carbonate salts of alkali metals such as sodium or potassium, and this output water of this stage may be the input water of the post-processing stage.

The input water may be decarbonised by admixing it with Strontium Chloride in the stoichiometric ratio to form a precipitate of Strontium Carbonate, which may be insoluble in water, removing the dissolved carbonate anions from the water and leaving behind desulfurised and decarbonised water with less than 1 gram per litre of dissolved carbonates other than carbonates of alkali metals.

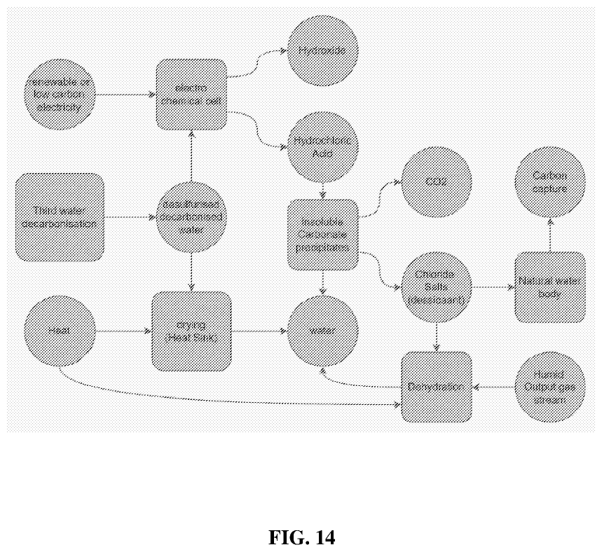

### 9) Output Water Post-Processing Stage (See FIG. 14)

This stage is for post-processing of the decarbonised desulfurised water.
Some or all of this desulfurised and decarbonised water may be dehydrated to release fresh water and form chloride brine or salts by using this water solution as the heat sink for the heat from the hot Zinc Oxide and hot CO₂, or the exothermic heat, or the heat from the industrial exhaust, optionally in conjunction with the usage of desiccant, which may be produced within this method, to dehydrate this desulfurised and decarbonised water.
Also, some or all of this desulfurised and decarbonated water or the brine may be used to prepare hydroxide and acid in an electrolytic cell; wherein
   the hydroxide may be used as the soluble hydroxide consumed at various steps in the method,
   while some acid may be used to release high purity CO₂ from the insoluble carbonate precipitates from the first decarbonisation stage thus producing soluble chloride and nitrate salts/salt solution of the cations (such as calcium or magnesium or lithium) that formed insoluble carbonate precipitates.
   The hydrogen produced from the electrolytic cell may be used as desired, such as to combine with the Nitrogen produced in the method to form ammonia.
Some of the chloride salts/solutions of cations (such as calcium, magnesium, or lithium) thus produced may be used as a solid or liquid desiccant to recover freshwater from the humid decarbonised desulfurised output gas stream produced by the method.
   The hydrated desiccant may be used as a heat sink to regulate temperature for the steps in the disclosed method in conjunction with the heat generated from the exothermic steps in the disclosed method, and the hot Zinc Oxide and hot CO₂ produced in the calcination step of the disclosed method, and waste heat from industrial sources.
Also, after being used to dehydrate the output gas stream, some or all the chloride solution may be reused as a desiccant or may be added back to the natural water bodies to capture carbon over a sustained period, thus supporting the marine ecosystem.

The carbonisation and decarbonisation cycle may also be performed by
c. replacing Zinc in the second decarbonisation stage with other cations whose aqueous chloride and sulphate are soluble while carbonate is non-soluble in water,
d. replacing Strontium in the desulphurisation stage with other salts whose aqueous chlorides are soluble while sulphates are non-soluble in water,
e. replacing Strontium in the third decarbonisation stage with other salts where aqueous chlorides are soluble while carbonates are non-soluble.

### Example C: a Method of Capturing Carbon Dioxide to Produce Clean Air and Water

### Technical Field of the Innovation

This innovation relates to a method of capturing water-soluble acidic gasses like carbon dioxide and sulphur dioxide to produce clean air and water.

### Background of the Innovation

The innovation may be used to capture CO₂ and acidic gasses from a variety of sources of CO₂, ranging from ambient air to industrial exhaust to concentrated CO₂ gas, thereupon combine the captured CO₂ with the cations and anions already present in the input water or additionally added to the water in a specific sequence to produce high purity salts and to produce clean air and water.

### Novelty Over Existing Technologies

Currently, technology is available to capture carbon using aqueous hydroxides like sodium hydroxide or potassium hydroxide to produce carbonates and bicarbonates of sodium and potassium. These are simple carbonisation technologies and suffer from several drawbacks. They don't contain the novel sequence of carbonisation and decarbonisation iterations used in this novel method, wherein the reaction is controlled to either promote or prevent carbonisation in specific stages, which is the key to this innovation enabling the production of high purity salts elegantly.

These carbon capture technologies produce a lot of exothermic heat, which thwarts carbon capture, thus needing expensive cooling arrangements. In comparison, this novel method contains stages that act as a heat sink for the exothermic heat produced in the carbon capture, thereby enhancing carbon capture effectiveness.

These carbon capture technologies consume a lot of water due to evaporative losses. In comparison, this novel method features a post-processing stage driven by the heat generated within the process to recover water from the output air/gas stream, thus significantly reducing water consumption.

Flue gas scrubbing technologies are available. These are either carbonate-based or hydroxide-based. The carbonate-based technologies cause substantial carbon emissions due to the liberation of CO₂ during the conversion of carbonates to sulphates. The hydroxide-based technologies suffer from slow and incomplete oxidation of sulphites to sulphates, so they need high temperatures and catalysts for this oxidation to occur. In comparison, this method features a novel mechanism to efficiently recover oxygen from the air/gas stream to oxidise sulphites to sulphates.

The carbonate calcination in existing technology works at upwards of 800 Degree Celsius to produce CO₂ gas. In contrast, this method may generate CO₂ gas at various steps even without calcination, and at the calcination step, it works at temperatures of 150-400 Degree Celsius only.

There are existing technologies to produce Zinc Carbonate. These are based on either concentrated solutions or dilute solutions. The technologies based on concentrated solutions suffer from excessive co-precipitation of unwanted Zinc hydroxide. The technologies based on dilute solutions suffer from excessive use of water and excessive carbonate scaling.

In comparison, this novel method uses an oscillating PH mechanism to produce zinc carbonate precipitate with reduced co-precipitation of Zinc Hydroxide. Moreover, this novel method uses this Zinc Hydroxide co-precipitation to produce hot, humid carbon dioxide, which is used in various stages in this method.

### Challenges in Existing Technologies Overcome by Disclosed Innovation

| | Drawbacks in Current | Advantages of the disclosed | |
|---|---|---|---|
| Challenge | Technology | innovation | Stage |
| Corrosion of | They use concentrated | This method uses dilute hydroxide | Second water- |
| Equipment | hydroxide, which | (up to 0.1 molar solution) with a | Carbonisation |
| | causes heavy | maximum PH of 13.0 in the second | stage |
| | equipment corrosion, | carbonisation stage and lower PH | |
| | increasing capital | values in all other stages, thus | |
| | expenditure and | significantly reducing equipment | |
| | maintenance costs. | corrosion and capital expenditure | |
| | | and maintenance costs. | |
| Environmental | Usage of concentrated | The last carbon capture stage is the | First |
| Damage | hydroxide causes the | First Carbonisation stage. This stage | Carbonisation |
| | carryover fumes to be | operates at mild alkaline PH < 11.5. | stage |
| | highly caustic with | Hence, the fumes do not cause | |
| | PH~14, which is lethal | environmental damage | |
| | to most lifeforms. | | |
| | Capital expenditure is | | |
| | needed to catch these | | |
| | fumes. | | |
| Salinity and | They lose a lot of water | The input water is softened in the | First Water- |
| hardness of | due to evaporation. | First Decarbonisation stage by | Decarbonisation |
| input water | Hence the | precipitating the insoluble | stage |
| | concentration of salts | carbonates and hydroxides, | |
| | increases very quickly | preventing unwanted scaling. So, it | |
| | in the water, so the | can use saline and hard water | |
| | carbonisation causes | sourced from natural water bodies | |
| | scaling & maintenance | or even the exhaust water from | |
| | issues. So, they use | industrial sources such as bleed | |
| | freshwater with low | water from boilers, etc. | |
| | salinity and low | | |
| | hardness to maintain | | |
| | sufficient cycles of | | |
| | concentration without | | |
| | causing scaling. | | |
| The strain on | Freshwater sources in | The disclosed innovation can | First water |
| Freshwater | nature, such as rivers | consume hard and saline water from | Decarbonisation |
| resources and | and lakes, are scarce, | natural water bodies or industrial | stage |
| its impact on | and water usage for | bleed water, so it doesn't compete | Post-processing |
| the marine | carbon capture | with alternate freshwater uses and | stages |
| ecosystem | competes with other | produces freshwater. Moreover, the | |
| | uses such as | first decarbonisation stage uses the | |
| | agriculture. The brine | hardness causing cations | |
| | disposal produced by | beneficially to produce carbonate | |
| | the carbon capture | precipitates which may be added to | |
| | process further strains | the ocean water to neutralise acidity | |
| | the freshwater sources. | in the marine ecosystem and | |
| | Moreover, the inability | support the natural carbon capture | |
| | to use industrial bleed | cycle. | |
| | water causes such | Further, this method can produce | |
| | bleed water to pollute | freshwater from the output water | |
| | the environment, | stream and recover water from the | |
| | thereby acidifying the | output air/gas stream in the | |
| | marine ecosystem and | integrated post-processing stages. | |
| | thwarting the natural | | |
| | carbon capture | | |
| | process. | | |
| Need for | The carbonate and | The oxide, sulphate, bicarbonate | Second water- |
| sorbent | bicarbonate salts | and carbonate salts produced by | Carbonisation, |
| regeneration | produced by the | this method are significantly more | second water |
| | existing technologies | remunerative than the input | decarbonisation, |
| | are typically not | materials like hydroxides, so the | water |
| | remunerative enough | regeneration of the sorbents is not | desulfurisation, |
| | to cover the cost of the | critically required for economic | third water- |
| | input materials like | viability. Nevertheless, regeneration | decarbonisation |
| | hydroxides, so the | may still be performed. | |
| | sorbents are generally | | |
| | regenerated, and the | | |
| | CO2 is sequestered, | | |
| | making this | | |
| | economically more | | |
| | viable. | | |
| Temperature | The sodium, potassium, | The calcination of the carbonate | Second Water- |
| of Calcination | or calcium carbonates | produced in the disclosed | Decarbonisation |
| | need high | innovation occurs at low | |
| | temperatures of | temperatures in the range of 150- | |
| | upwards of 800 | 400 Degree Celsius. This low- | |
| | Degrees Celsius. This | temperature heat can be easily | |
| | intense heat cannot be | achieved from natural sources such | |
| | easily generated from | as concentrated solar and is readily | |
| | solar or other natural | available as low-grade industrial | |
| | sources and is typically | waste heat. Thus, the carbon | |
| | not available as | capture efficiency is not degraded. | |
| | industrial waste heat. | | |
| | Hence, this calcination | | |
| | consumes fossil fuels or | | |
| | electricity generated | | |
| | from renewable | | |
| | sources, significantly | | |
| | degrading the net | | |
| | carbon capture | | |
| | efficiency. | | |
| Reaction | The Hydroxide to | The disclosed innovation upcycles | Second Water- |
| Kinetics vs | Carbonate reaction | the carbonates to more valuable | carbonisation, |
| Economic | kinetics is very fast but | salts to address economic viability. | Second Water- |
| viability for | has the disadvantage | | carbonisation, |
| Carbonate | that two moles of | | third water- |
| production | hydroxide are | | Decarbonisation |
| | consumed for every | | |
| | mole of carbonate | | |
| | produced; hence the | | |
| | technologies that make | | |
| | carbonate are very fast | | |
| | but not economically | | |
| | viable. | | |
| Reaction | The hydroxide to | The disclosed innovation first uses | Second water |
| Kinetics vs | bicarbonate reaction | the source of CO2 to prepare | decarbonisation |
| Economic | kinetics is very slow. | concentrated CO2 in the second | Second water |
| viability for | Still, it has the | water-decarbonisation stage. It then | carbonisation |
| Carbonate | advantage that only | uses concentrated CO2 at higher | |
| production | one mole of hydroxide | pressures to produce bicarbonate in | |
| | is consumed for every | the second water-carbonisation | |
| | mole of bicarbonate | stage, thus achieving fast reaction | |
| | produced; hence the | kinetics. | |
| | technologies that make | | |
| | bicarbonate are | | |
| | economically viable but | | |
| | very slow. | | |
| Co-Production | The standard | The disclosed innovation uses a | Second water |
| of Zinc | technology uses | novel oscillating PH mechanism in | decarbonisation |
| Hydroxide | concentrated solutions | the second water decarbonisation | |
| along with | of Zinc | stage to extract the water at | |
| Zinc | Chloride/sulphate and | preferred stoichiometric points | |
| Carbonate | concentrated solution | during the oscillations, thereby | |
| | of aqueous Carbonate | significantly minimising the co- | |
| | to produce zinc | formation of Zinc Hydroxide during | |
| | carbonate and suffers | precipitation of Zinc Carbonate. | |
| | from the unwanted co- | | |
| | precipitation of Zinc | | |
| | Hydroxide leading to | | |
| | the formation of Basic | | |
| | Zinc Carbonate. This | | |
| | wastes a significant | | |
| | proportion of the input | | |
| | of Zinc and poses | | |
| | tremendous challenges | | |
| | to separating Zinc | | |
| | Hydroxide from Zinc | | |
| | Carbonate. | | |
| Scaling of Zinc | In the standard | In the disclosed innovation, the | Third |
| Carbonate | technology, when the | output water from the second | water |
| | water is recirculated | water-decarbonisation stage | carbonisation |
| | after the formation of | becomes the input water for the | |
| | Zinc Carbonate, the | third water-carbonisation stage. If | |
| | small amount of | some Zinc ions are carried along | |
| | remaining aqueous zinc | with water to the third water | |
| | forms scaling when it | carbonisation stage, these zinc ions | |
| | encounters aqueous | form insoluble carbonate | |
| | carbonates, which is | precipitate in the third water | |
| | very difficult and | carbonisation stage. This precipitate | |
| | expensive to treat. | may be extracted and added to the | |
| | | Zinc Carbonate precipitate formed | |
| | | in the second water- | |
| | | decarbonisation stage. Thus, the | |
| | | Zinc ions are successfully recovered, | |
| | | and the scaling is minimised in | |
| | | subsequent stages. | |
| Co- | In the existing | The disclosed innovation uses a | Water |
| precipitation | technology, carbonate- | novel mechanism to prepare | desulfurisation |
| of Strontium | free water needs to be | decarbonised water by precipitating | stage |
| Carbonate | used to prepare | aqueous carbonates by treatment | |
| during the | Strontium Sulphate | with Zinc Chloride/Sulphate. The Kₛₚ | |
| production of | since any contact | of Zinc carbonate is lower than the | |
| Strontium | between aqueous | Kₛₚ of Strontium Carbonate, and | |
| Sulphate | Strontium and aqueous | exposure to CO2 is controlled. Thus, | |
| | Carbonate results in co- | high purity Strontium Sulphate is | |
| | precipitation Strontium | formed in the water desulfurisation | |
| | Carbonate. This is | stage since the concentration of | |
| | challenging and | remaining aqueous carbonates is | |
| | expensive because | below the threshold needed to form | |
| | even very pure distilled | Strontium Carbonate precipitate. | |
| | water will quickly | | |
| | absorb CO2 from the air | | |
| | and form enough | | |
| | aqueous carbonates to | | |
| | form Strontium | | |
| | Carbonate precipitate. | | |
| Co- | In the existing | The disclosed innovation uses a | Various stages |
| precipitation | technology, sulphate- | novel mechanism to produce | |
| of Strontium | free water needs to be | sulphate free water by precipitating | |
| Sulphate | used to prepare | Strontium Sulphate in the water | |
| during the | Strontium Carbonate | desulfurisation stage and then | |
| production of | since any contact | carbonises this sulphate-free water | |
| Strontium | between aqueous | in the third water-carbonisation | |
| Carbonate | Strontium and aqueous | stage by using the high purity | |
| | Sulphate results in co- | sodium carbonate precipitate | |
| | precipitation of | produced in the second water | |
| | Strontium Sulphate. | carbonisation stage, thus producing | |
| | This is challenging | high purity Strontium Carbonate in | |
| | because sulphate free | the third water-decarbonisation | |
| | water is expensive to | stage. | |
| | produce, such as | | |
| | distillation! | | |
| High purity | In existing | The disclosed innovation produces | Water post- |
| NaCl | technologies, to | brine where the NaCl:KCl ratio is | processing stage |
| | produce NaCl, typically | significantly higher than the | |
| | seawater is used to | NaCl:KCl ratio in the input water, thus | |
| | prepare salt by | producing high purity NaCl | |
| | desalination. This | brine/salt. | |
| | usually contains 5 | | |
| | grams of KCl for every | | |
| | 100 grams of NaCl. An | | |
| | expensive process is | | |
| | needed to remove | | |
| | some KCl from the | | |
| | NaCl—KCl mixture to | | |
| | produce high purity | | |
| | NaCl. | | |

### Example D: Integrated System of Capturing Carbon

Also disclosed herein are systems and methods which are able to capture carbon such as carbon dioxide (CO₂) in various forms and from various sources in one single arrangement, without using massive amounts of energy to move large amounts of air through alkaline scrubbers to capture CO₂ from air, in a thermally more energy-efficient manner.

Advantages may include provision of an environmentally friendly process. CO₂ may be captured using sodium hydroxide (NaOH), and be regenerated by calcining ZnCO₃. As compared to state of the art processes involving CaCO₃ calcination, ZnCO₃ thermal dissociation step used in methods disclosed herein may consume a small fraction of “heat of dissociation” as compared to heat of dissociation of CaCO₃, and occur at a much lower temperature of 250° C. to 400° C. instead of greater than 900° C. needed for CaCO₃ dissociation. Energy that is needed to run so many fans to move so much air for direct capture of CO₂ from air may be avoided, and yet methods disclosed herein are able to capture CO₂ from air directly. Further advantages may relate to production of high purity zinc oxide using methods disclosed herein. It is a valuable product versus calcium oxide, which is not produced as a high purity product and is not a valuable product. As such, zinc oxide obtained from methods disclosed herein may be directly used as a product, as compared to state of the art methods involving recycling of calcium oxide to capture more CO₂. This makes methods disclosed herein thermally more efficient by preventing the loss of heat generated from dissolution of calcium oxide in water to produce calcium hydroxide which is normally used in the state of the art industry processes to capture carbon. Using a method disclosed herein, zinc carbonate may be obtained. The industry may face a challenge in terms of the composition of zinc carbonate and zinc hydroxide, thereby resulting in significant amount of energy loss. Methods disclosed herein are able to address or at least alleviate the above problem by achieving majority of the composition of the mixture as zinc carbonate.

### Description of Input Source of CO₂—Air, Water and Flue Gas

The following may describe attributes of air, water and flue gas for use in methods disclosed herein.
Air—filtered air, relatively free from dust.
Water—filtered water, relatively free from bacteria/undissolved suspended impurities.
Flue gas—filtered smoke, relatively free from suspended particles.

### Example 1: Carbon Dioxide Capture from Water (Stage 1)

### Step 1.1 Water Capacity

A plurality of water tanks, such as three water tanks, may be provided. Each tank may have 1 m³ of holding capacity, such that each tank of water may contain up to 1000 liters of water. For illustration purposes, each tank of water holds 1000 liters of water, and denoted as Tank-A, Tank-B, and Tank-C.

### Step 1.2 Water Source

Regarding the water contained in the tanks, water from a natural source, such as rainwater, river, lake or sea, or from household such as well or tap, or from industry such as brine from a water desalination plant or wastewater from an industrial boiler, may be used for a first cycle. The water may be filtered to remove undissolved impurities and suspended particles, and/or may be sanitized to remove bacteria.

In subsequent cycles, such as second cycle, third cycle and so on, water from Step 4 or fresh water generated from Step 9 (as will be discussed below) may optionally be used or reused.

Step 1.3 pH Measurement of Water from Water Source

pH of the water is measured. If pH of the water is less than 7, some alkali such as sodium hydroxide (NaOH) may be added so as to increase pH of the water to at least pH 7.0.

### Step 1.4 Addition of Sodium Carbonate

To each tank of 1000 liters of water, 16.2 g of sodium carbonate (Na₂CO₃) per liter of water is added. Thus, 16.2 kg of Na₂CO₃ is added for the 1000 liters of water in each tank. In the first cycle, Na₂CO₃ sourced externally may be used. In subsequent cycles, Na₂CO₃ precipitated or sourced from Stage 2 (for example Step 2.6), or Stage 3 (for example, Step 3.4), as will be discussed below, may be used.

### Step 1.5 Precipitate Formation Following Addition of Sodium Carbonate

If precipitate is formed, the precipitate may be filtered out so as to obtain a clear filtered solution. Possible precipitates may include, but are not limited to, carbonate precipitates of metals such as calcium and magnesium.

For example, calcium carbonate (CaCO₃) may be formed based on the following reaction:

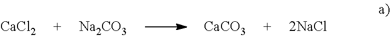

If typical or standard seawater is used, it may contain approximately 400 mg of dissolved calcium per litre of water on average. Accordingly, approximately 1.1 kg of Na₂CO₃ may be consumed in each water tank to form approximately 1 kg of CaCO₃, which may be precipitated out in each water tank, and 1.2 kg of dissolved sodium chloride (NaCl).

CaCO₃ has very low solubility in water of only approximately 15 mg per liter. Therefore, for every 1000 liters of water, there may only be approximately 15 g of CaCO₃ that remain dissolved in water following CaCO₃ precipitation.

As a further example, magnesium carbonate (MgCO₃) may be formed based on the following reaction:

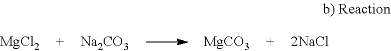

If typical seawater is used, it may contain approximately 1262 mg of dissolved magnesium per litre of water on average. Accordingly, approximately 5.5 kg of Na₂CO₃ may be consumed in each water tank to form approximately 4.4 kg of magnesium carbonate (MgCO₃), which may be precipitated out in each water tank, and approximately 3 kg of dissolved NaCl.

MgCO₃ is slightly soluble in water, of approximately 220 mg per litre. Therefore, for every 1000 litres of water, there may be approximately 220 g of MgCO₃ that remain dissolved in water following MgCO₃ precipitation.

Taking both reactions a) and b) mentioned above into consideration, a total of approximately 6.6 kg of Na₂CO₃ may be consumed, while approximately 9.6 kg of Na₂CO₃ may remain dissolved in each 1000 litres of water.

### Step 1.6 pH Measurement of Water Following Precipitation, and Addition of Sodium Hydroxide

Following this, pH of water is measured. If the pH is less than 12.5, an alkali such as NaOH may be added to bring pH up to 12.5. Additional NaOH may be added to increase concentration of NaOH up to 15.35 g of NaOH per liter of water. Accordingly, a total of approximately 15.35 kg of NaOH may be added to each 1000 liters of water. The NaOH may be sourced externally, or from Step 7 (as will be discussed below).

### Step 1.7 Hydroxide Precipitation Following Addition of Sodium Hydroxide

If any precipitate is formed, the precipitate may be filtered out so as to obtain a clear filtered solution. Possible precipitates may include, but are not limited to, hydroxide precipitates of metals such as magnesium, that are still left behind in the water solution and whose hydroxide salt is less soluble in water than their carbonate salts.

For example, magnesium hydroxide (Mg(OH)₂) may be formed based on the following reaction:

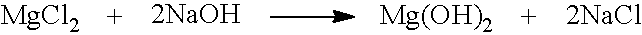

If typical seawater is used, and MgCO₃ is already precipitated out based on the reaction mentioned above, then approximately 2.6 moles of Mg(OH)₂ may be precipitated, amounting to approximately 150 g of Mg(OH)₂. 210 g of NaOH may be consumed, and approximately 300 g of dissolved NaCl may be formed and added to the water.

Mg(OH)₂ has very low solubility in water of approximately 12.2 mg per litre. As such, after Mg(OH)₂ is precipitated, there may only be approximately 12.2 g of Mg(OH)₂ that remain dissolved in each 1000 litre of water.

### Step 1.8 Carbonate Formation Following Addition of Sodium Hydroxide

Dissolved CO₂ or bicarbonate ions in the water may be converted to carbonate ions. For example, bicarbonate ions in the water may be converted to carbonate ions based on the following reaction:

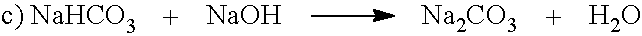

If typical seawater is used, 0.003 moles of bicarbonate ion may be present per litre. Accordingly, each 1000 litre of water may contain 3 moles of bicarbonate ions. 120 g of NaOH may be consumed in this step to add 318 g of dissolved Na₂CO₃ to water.

For example, dissolved CO₂ in the water, which may be in the form of H₂CO₃, may be converted to carbonate ions based on the following reaction:

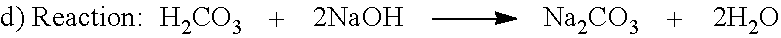

If typical seawater is used, then 0.0003 moles of organic dissolved CO₂ may be present per litre. Accordingly, 0.3 moles of dissolved CO₂ may be contained in each 1000 litre of water. Therefore, for each 1000 litre of water, only 24 g of NaOH may be consumed in this step to add 63 g of dissolved Na₂CO₃ to water.

Taking Step 1.7 and Step 1.8 into consideration, a total of approximately 350 g of NaOH may be consumed, while the remaining 15 kg of NaOH may remain dissolved in each 1000 litres of water solution. Approximately 380 g of dissolved Na₂CO₃ may be added to the water solution, taking total Na₂CO₃ content to approximately 10 kg per 1000-liter of water solution.

Addition of the sodium carbonate and sodium hydroxide in Step 1.4 and Step 1.6 respectively may be adjusted to ensure that water at this step contains approximately 10 kg of Na₂CO₃ per 1000 litre of water and 15 kg of NaOH per 1000 litre of water.

### Step 1.9 Sodium Chloride Content in Water

Typical seawater may contain 28.0 g of NaCl per litre of water. Therefore, 28 kg of NaCl may be contained in each 1000 liter of water. To this, approximately 4.5 kg of NaCl may be added. Thus, concentration of NaCl may increase to approximately 32.5 kg per 1000 liter of water solution. Depending on the NaCl concentration in the input water used in this step, and adjustment amounts of salts used in above steps, the final NaCl concentration may vary below or above this amount.

### Step 1.10 Sodium Carbonate and Sodium Hydroxide Content in Water

Each of the three 1000-liter water solution tanks may have 10 kg of Na₂CO₃ and 15 kg of NaOH dissolved in the water.

### Step 1.11 Adjusting Sodium Carbonate and Sodium Hydroxide Content in Water

If the water used in Step 1.1 is not typical seawater with the mentioned concentrations in various Step 1.1 to 1.9, or has a different composition than typical seawater, amounts of sodium carbonate and sodium hydroxide added in various Step 1.1 to 1.9 may be adjusted, to achieve a net outcome of the mentioned concentration of sodium carbonate and sodium hydroxide in Step 1.10, within an error rate such that the pH of water is at least 13.5 at this point.

### Step 1.12 Water Content in the Tanks

Although it is mentioned in Step 1.1 regarding separation of the water in three tanks, the water may be separated in any of the steps mentioned above, or at Step 1.11 when chemical treatment of the water is completed. Outcome is three separate tanks of water with concentration of sodium carbonate and sodium hydroxide as mentioned in Step 1.11.

### Step 1.13 Scaling of Calculations

The calculations mentioned above may be scaled up or down proportionally, as the quantity of water is scaled up or down.

Step 1.14 Possible End Point for Transfer from Stage 1 to Stage 2

A possible end point for transfer of capture medium from Stage 1 to Stage 2 may depend on the following factors.

Firstly, when the Na₂CO₃ is added, and the insoluble carbonates are precipitated, the minimum end point may be the point at which addition of more Na₂CO₃ does not result in precipitation of more insoluble carbonates.

Secondly, after this, when NaOH is added, and the insoluble hydroxides are precipitated, an end point may be the point at which addition of more NaOH does not result in precipitation of more insoluble hydroxides.

Even though more Na₂CO₃ and more NaOH may be added even after precipitation stops, the above may be the minimum end points to complete precipitation of first the insoluble carbonates then the insoluble hydroxides. Said differently, the end point may be the point at which addition of Na₂CO₃ does not result in precipitation of insoluble carbonates, and addition of NaOH does not lead to precipitation of insoluble hydroxides.

### Example 2: Carbon Dioxide Capture from Air (Stage 2)

Step 2.1 Preparation of Water for Carbon Dioxide Capture from Air

Take Tank-A containing 1000-liter solution from Example 1. Water from Tank-C may be used to top up water level in Tank-A during this step to compensate for water loss due to evaporation.

### Step 2.2 Concentration of Sodium Hydroxide in Water

Concentration of NaOH may be increased to approximately 4 Molar, meaning that increase concentration of NaOH may be increased to approximately 160 g of NaOH per litre of water. That is, for 1000 litres solution, approximately 160 kg of NaOH may be added.

### Step 2.3 Exposure of Water to Air

Expose this water solution to air, which may be ambient air in the atmosphere, or may be indoor air which may contain a higher concentration of CO₂ than ambient air, due to generation of CO₂ that is breathed out by living beings, including humans.

Several optional methods may be used to speed up CO₂ capture process from air. For example, surface area of air-water interface may be increased.

This may be carried out by spreading this 1000 litres of water on a larger surface area, such as on 10 m² with approximately 10 cm height of water column. For example, 10 trays of 1 m² base area each and water height of around 10 cm may be used.

As another example, water may be allowed to drip down to lower trays and a water pump may be used to circulate water from a bottom tray to a top tray.

As a further example, stirring of the water solution may be carried out to maintain turbulence.

### Step 2.4 Positioning of Water Tank

The 1000 litres of water solution may be positioned in, well ventilated, windy space, such as a duct taking airflow out from an indoor space like a commercial building, or a duct taking airflow to the combustion system, to capture CO₂ from the air flow, or simply let it contact ambient air in a well-ventilated arrangement.

The following reaction may take place:

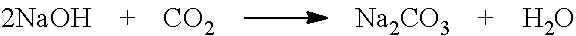

Approximately 2.4 kg of Na₂CO₃ may be produced for every kg of CO₂ captured from air, and 1.8 kg of NaOH may be consumed per kg of CO₂ captured from air.

### Step 2.5 pH Measurement and Adjustment of pH

A pH measuring device may be used to add more NaOH to maintain pH>13.5 in water solution. At least 12.6 kg of NaOH may always remain dissolved per 1000 litres of water solution.

Step 2.6 Formation of Na₂CO₃

Solubility of Na₂CO₃ is approximately 215 g per litre. So, for 1000 litres, up to 215 kg of Na₂CO₃ can be dissolved. Na₂CO₃ is not expected to precipitate out in this step until approximately 88 kg of CO₂ is captured by consuming all of the 160 kg of NaOH added in Step 2.2 mentioned above. If any precipitate is formed, the precipitate is removed. This may be precipitate of Na₂CO₃ formed by capturing CO₂ from air, and may be used in Stage 1 (for example Step 1.4) or Stage 4 (for example Step 4.1).

### Step 2.7 Capturing of CO₂

The desired amount of CO₂ from air may be captured, all the while maintaining pH>13.5. The amount of CO₂ captured may be lower than what is required to form enough Na₂CO₃ to cross the solubility limit of Na₂CO₃ in the water solution.

### Step 2.8 Further Optional Treatment of Air

Optionally, the air going out after contacting this NaOH solution with pH>13.5 may be exposed to water with pH lower than pH 9.0 to avoid harmful effects of carrying over of high pH droplets of NaOH solution in the air.

Step 2.9 Possible End Point for Transfer from Stage 2 to Stage 3

A possible end point may be that the pH of water does not drop below 12.0 without addition of more NaOH. For example, if addition of NaOH is stopped and Stage 2 involving capture of CO₂ from air is continued, pH of the water may drop because the CO₂ in air may combine with NaOH in water to produce Na₂CO₃ whose pH is below 12, thereby continuously dropping the pH of water from 14 towards 12.0. Below the pH 12.0, however, the process may become so slow that it may become uneconomically slow. A higher pH may be preferred for efficiency, such as at least pH 13.5 or well above pH 13.5 in actual implementation. For processing efficiency, pH may not fall below 12 before transferring to Stage 3. It may also be possible to simply transfer at pH 13.5 itself to Stage 3.

### Example 3: Carbon Dioxide Capture from Flue Gas (Stage 3)

Step 3.1 Water from Stage 2 for Use

Output from Stage 2 in the form of a 1000-liter of pH 13.5 NaOH solution from Tank-A may be used.

Smoke may be collected in inverted tube or pipe above this NaOH solution to capture CO₂ from smoke. Water from Tank-C may be used to top up water level in Tank-A during this step to compensate for water loss due to evaporation.

### Step 3.2 Enhancing Dissolution of CO₂

The inverted tube/smoke pipe may contain a misting device, which may be used to speed up dissolution of CO₂ in the NaOH solution.

### Step 3.3 Adjust pH of Solution to 13.5 and Above

Use pH measuring device, more NaOH may be added to maintain pH above 13.5 in the water solution. In so doing, at least 12.6 kg of NaOH may always remain dissolved per 1000 litres of water solution. If precipitate is formed, the precipitate is removed.

Addition of the NaOH may result in the following reaction:
2NaOH+CO₂→Na₂CO₃+H₂O, when pH is high, above pH 13.5

The Na₂CO₃ may precipitate. Approximately 2.6 kg of Na₂CO₃ may be produced for every kg of NaOH consumed, and 1.1 kg of CO₂ may be captured from the smoke.

It may be expected that up to approximately 350 kg of sodium hydroxide (NaOH) is used in this step, to produce approximately 460 kg of sodium carbonate (Na₂CO₃). Of the sodium carbonate formed, approximately 250 kg may be precipitated, and approximately 210 kg may remain dissolved in water. Approximately 190 kg of CO₂ may be captured from smoke in this step.

Step 3.4 Na₂CO₃ Precipitation

Precipitate of sodium carbonate may be removed, if formed, for use in Stage 4 (for example, Step 4.1) or Stage 1 (for example, Step 1.4). Amount of Na₂CO₃ precipitated in this stage may be scaled up or down, such that NaCl is not precipitated in the Stage 4 at Step 4.1.

### Step 3.5 End Point for Stage 3

In Stage 3, highly soluble Na₂CO₃ may be produced in solution. When solubility limit is exceeded, excess Na₂CO₃ may be precipitated out. The dissolved and the precipitated Na₂CO₃ may be processed with ZnCl₂ to produce NaCl and ZnCO₃. ZnCO₃ may be an insoluble precipitate, while NaCl is very highly soluble in water. When solubility limit of NaCl is exceeded, however, excess NaCl may be precipitated. NaCl may be kept soluble in solution so as to prevent contamination of ZnCO₃. As such, a possible end point may be to stop before NaCl is precipitated, or such that solubility limit of NaCl is not exceeded. To remove NaCl from the solution so as to push the end point forward, a bipolar membrane cell to extract Na and Cl ions from the solution may be used to allow more NaCl to be formed before reaching solubility limit. Some Na₂CO₃ may be formed by capture of CO₂ from air in Stage 2, and some Na₂CO₃ may be formed by capture of CO₂ from smoke in Stage 3. Combined amount of Na₂CO₃ may not exceed the amount that will result in NaCl precipitation, so that NaCl precipitation does not contaminate ZnCO₃ precipitate.

This may be a combined end point for both Stage 2 and Stage 3. If Stage 2 runs for a long time, then Stage 3 may be shortened. If Stage 2 is entirely skipped, for example, then Stage 3 may have maximum run length.

### Example 4: Thermochemical Process (Stage 4, Involving Steps 4 to 6)

### Step 4.1 Conversion of Precipitated Sodium Carbonate to Zinc Carbonate

1000 litre of water sourced from Tank-B from Stage 1 containing approximately 15 kg of sodium hydroxide and 10 kg of sodium carbonate may be used.

The 250 kg of sodium carbonate precipitated from Stage 2 and Stage 3 may be taken. Some water solution may be mixed with the sodium carbonate precipitate, and it does not need to be totally dry. This precipitate may be added to the water in Tank-B, so that there is a total 260 kg of sodium carbonate in Tank-B.

Approximately 365 kg of zinc chloride may be added to the water solution in Tank-B.

The following precipitation reactions may take place:

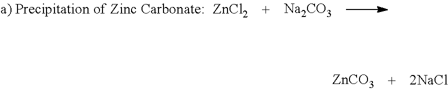

For every kg of Na₂CO₃, approximately 1.3 kg of ZnCl₂ may be consumed. Approximately 1.2 kg of ZnCO₃ may be precipitated and 1.1 kg of NaCl may be formed. For the 260 kg of sodium carbonate mentioned above, approximately 335 kg of zinc chloride may be consumed, and approximately 305 kg of zinc carbonate precipitate may be formed. The zinc carbonate precipitate may be filtered out for use in Step 5.

b) Precipitation of Zinc Hydroxide: ZnCl₂+2NaOH→Zn(OH)₂+2NaCl

For every 1 kg of NaOH contained in the solution, approximately 1.7 kg of ZnCl₂ may be consumed, and approximately 1.25 kg of Zn(OH)₂ precipitate may be formed. The precipitate of Zn(OH)₂ may be filtered out for use in Step 5.

It may be expected that 1000 litre of water sourced from Stage 1 has approximately 15 kg of dissolved NaOH, so approximately 18.75 kg of Zn(OH)₂ may be precipitated and approximately 25.5 kg of ZnCl₂ may be consumed. Approximately 22 kg of dissolved NaCl may be produced.

There may be release of CO₂, in that some CO₂ gas may be bubbled out, especially if bicarbonate ions are present in water, via the following reaction:

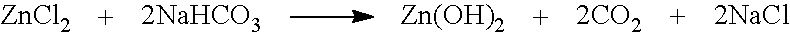

The CO₂ gas may be collected and combined with CO₂ gas from Step 5 to use within methods disclosed herein, or be stored for sale or for alterative purposes.

305 kg of zinc carbonate precipitate and approximately 18 kg of zinc hydroxide precipitate may be filtered out to obtain clear saline water. The clear saline water may be used in Step 7 or Step 9 (as will be discussed below).

At this point, approximately 340 kg of sodium chloride may be in the 1000-liter water solution in Tank-B. Therefore, it is an approximately 95% concentrated brine, considering the 32.5 kg present per 1000-litre water after Stage 1 and the NaCl produced in this stage.

Depending on the variation of NaCl concentration in the water produced after Stage 1, Step 4.1 (i.e. current step) may be scaled by taking in less or taking in more Na₂CO₃ from Stage 3, such that concentration of NaCl remains below 95% of the solubility limit after current step, to avoid precipitation of NaCl.

### Step 4.2 Conversion of Dissolved Sodium Carbonate to Zinc Carbonate

1000 litre of water in Tank-A as sourced from Stage 3 may be used. It may contain 210 kg of dissolved Na₂CO₃, approximately 12.6 kg of dissolved NaOH and 32.5 kg of dissolved NaCl. ZnCl₂ may be mixed in to this water as per below steps.

ZnCl₂ may react with Na₂CO₃ with the following reaction:

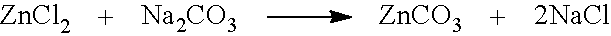

For every kg of Na₂CO₃, approximately 1.3 kg of ZnCl₂ may be consumed. Approximately 1.2 kg of ZnCO₃ precipitate, and 1.1 kg of NaCl may be formed.

It may be an expectation that this 1000 litre of water solution sourced from Step 3.3 contains approximately 210 kg of Na₂CO₃ dissolved in it. Hence, approximately 270 kg of ZnCl₂ may be consumed. 250 kg of ZnCO₃ precipitate and 233.5 kg of dissolved NaCl may be formed. Depending on various factors such as ambient temperature and pressure, and concentration of other salts in water, solubility of Na₂CO₃ in water may decrease or increase. Thus, Na₂CO₃ dissolved in the 1000 litre water sourced from Stage 3 may be less or more than 210 kg. Accordingly, addition of ZnCl₂ in this step may be scaled up or down to consume substantially all of the dissolved Na₂CO₃.

The precipitate of ZnCO₃ may be filtered out and used in Step 5.

ZnCl₂ may react with NaOH with the following reaction:

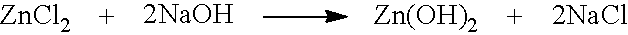

For every 1 kg of NaOH contained in the solution, approximately 1.7 kg of ZnCl₂ may be consumed. Approximately 1.25 kg of Zn(OH)₂ precipitate may be formed.

The precipitate of Zn(OH)₂ may be filtered out and used in Step 5.

It may be an expectation that 1000 litre of water sourced from Step 3.3 has approximately 12.6 kg of dissolved NaOH. Therefore, approximately 20 kg of ZnCl₂ may be consumed. Approximately 15 kg of Zn(OH)₂ may be precipitated and approximately 17.5 kg of dissolved NaCl may be produced.

ZnCl₂ may react with NaHCO₃ with the following reaction:

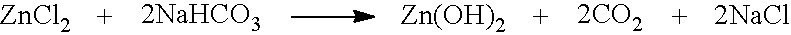

For every kg of NaHCO₃, approximately 0.8 kg of ZnCl₂ may be consumed. 0.6 kg of Zn(OH)₂ precipitate may be produced, and 0.5 kg of CO₂ gas may be bubbled out. The CO₂ gas may be collected and combined with CO₂ gas from Step 5 to use within the present method, or to store or use for alterative purposes.

The precipitate of Zn(OH)₂ from the above reactions may be filtered and used in Step 5.

It may be an expectation that not much NaHCO₃ is present in water sourced from Step 3.3 due to high pH (>13.5) of water in that step.

The 250 kg ZnCO₃ and 15 kg Zn(OH)₂ precipitates may be filtered off to obtain clear NaCl water. This water may be reused in Stage 1, thereby ensuring that NaCl does not precipitate in this whole process.

Since 251 kg of NaCl may be added in this step, and 32.5 kg of NaCl is already present, a total of 283.5 kg NaCl may now be present in 1000-liter water solution. This is approximately 79% of maximum solubility of NaCl in water. However, depending on the variation of NaCl concentration in water produced after Stage 1, concentration of NaCl in this step may be less or more than the 79% of the solubility limit. Addition of ZnCl₂ in this Step 4.2 may be scaled down to ensure that concentration of NaCl remains below 95% of the solubility limit after Step 4.2, to avoid precipitation of NaCl.

### Step 5 Calcination at 400° C.

This mixture of zinc carbonate/zinc hydroxide may be taken and heated up to a temperature at minimum of 250° C. and maximum of 400° C. The following reaction may take place:

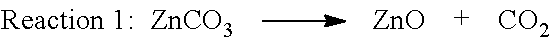

For every kg of ZnCO₃, approximately 0.65 kg of ZnO may be produced, and 0.35 kg of hot CO₂ may be released.

It may be an expectation that total of approximately 550 kg of ZnCO₃ may be sourced from Step 4.1 and Step 4.2, thus 355 kg of ZnO may be produced and 190 kg of pure CO₂ may be liberated.

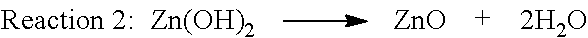

For every kg of Zn(OH)₂, approximately 0.8 kg of ZnO may be produced, and 0.18 kg of hot H₂O steam may be released.

It may be an expectation that a total of approximately 33.75 kg Zn(OH)₂ may be sourced from Step 4.1 and Step 4.2, thus approximately 27 kg of ZnO may be produced and approximately 6 kg of steam may be produced.

Mixture of the hot CO₂ and hot H₂O steam may be cooled down by using its heat to preheat the zinc carbonate/zinc hydroxide mixture before it is finally heated to 400° C., and remaining heat from the hot CO₂/H₂O steam may be used for thermal desalination of water to produce pure water for use in the Stage 1 of the method according to embodiments. The heat may alternatively be used for other purposes.

The 190 kg of CO₂ mixed with 6 kg of steam may be collected for further use in Step 6. In addition or alternatively, the CO₂ and H₂O may be collected in bottles in the form of soda water, and be sold or used for alternate purpose.

The 380 kg of zinc oxide residue from the present step may be collected, and bagged for sale or use for alternate purposes. Total weight of the ZnO may vary depending on total amount and composition of the mixture of ZnCO₃ and Zn(OH)₂ sourced from Step 4.1 and Step 4.2.

### Step 6 Capture Pure CO₂

The humid CO₂ gas from Step 5 may be collected in an inverted tube above NaOH/Na₂CO₃ solution. The humid CO₂ gas may react with NaOH with the following reaction:

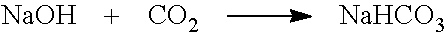

For every kg of CO₂ gas captured, approximately 0.9 kg of NaOH may be used up. Approximately 1.9 kg of NaHCO₃ may be produced. This is baking powder. Thus, for 190 kg of CO₂ gas, approximately 175 kg of NaOH may be consumed, and 360 kg of NaHCO₃ may be produced.

The humid CO₂ gas may react with Na₂CO₃ with the following reaction

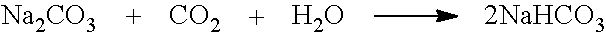

For every kg of CO₂ gas captured, approximately 2.4 kg of Na₂CO₃ may be used up. Approximately 3.8 kg of NaHCO₃ may be produced. This is baking powder. Thus, any leftover Na₂CO₃ from above steps may also be consumed in this step.

Optionally, misting device in the inverted tube may be used to speed up dissolution of CO₂ in the NaOH/Na₂CO₃ solution.

Thus, approximately 360 kg of NaHCO₃ may be produced. It may be bagged for sale or use for alternate purposes. The amount of NaHCO₃ produced in this step may vary depending on the amount of CO₂ consumed in this step.

Approximately 175 kg of NaOH may be consumed. It may be sourced externally or from Step 7.

Optionally, this CO₂ may be used for other purposes instead of making baking powder.

### Example 5: Further Steps for Improving Economics and Make the Process More Environment Friendly

Following 4 steps (Steps 7 to 10) are optional, and may be added to improve the economics and make the process more environment friendly.

Step 7 Produce Sodium Hydroxide, Hydrochloric Acid, Hydrogen Gas and Oxygen Gas from Concentrated Brines Produced in Steps 4.1 and 4.2

2000 litre of highly concentrated brine from Steps 4.1 and 4.2 may be collected. Bipolar electrodialysis using carbon neutral renewable low-cost electricity like solar energy without battery usage may be used to maintain electricity cost well below 10 cents per kWh.

This may consume 1.8 to 2.4 kWh of electricity per kg of sodium hydroxide, thereby producing sodium hydroxide at roughly the same price as cost of externally sourced sodium hydroxide. One advantage is that the sodium hydroxide produced may already be aqueous.

Moreover, this step may also produce over several hundred kg of hydrochloric acid (HCl), and produce green H₂ and green O₂ gas.

Advantageously, all of the sodium chloride present from the brine production Steps 4.1 and 4.2, and the sodium chloride present in the source of water in Stage 1 may be used up. Thus, it may address the challenge of discarding the brine and enables use of hypersaline discharge of water desalination plants as the source of clean filtered water in Stage 1, thereby improving environmental friendliness of this carbon capture process and environmental friendliness of the water desalination plants if their output brine is used as source water in this process.

Step 8 Release CO₂ from Precipitates Produced in Stage 1

Hydrochloric acid from Step 7 (or externally sourced) may be used to release CO₂ from calcium carbonate and magnesium carbonate precipitates produced in Stage 1.

For example, calcium carbonate may react with hydrochloric acid using the following reaction:

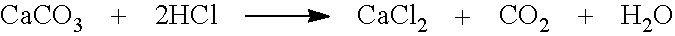

Approximately 3 kg of CaCO₃ may be sourced from Stage 1 if typical or standard seawater is used as source of water in Stage 1. 1.3 kg of CO₂ may be released, and some amount of HCl may be consumed, equivalent to approximately 2.2 kg of pure HCl, and approximately 3.33 kg of CaCl₂) may be produced.

Depending on calcium concentration in the source water used in Stage 1, amount of CaCO₃ sourced from Stage 1 may vary.

As a further example, magnesium carbonate may react with hydrochloric acid using the following reaction:

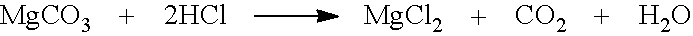

Approximately 13.2 kg of MgCO₃ may be sourced from Stage 1, if typical or standard seawater is used as source of water in Stage 1. This may release 6.9 kg of CO₂ and may consume some amount of HCl, equivalent to approximately 11.5 kg of pure HCl. Approximately 14.9 kg of MgCl₂ may be produced.

Depending on magnesium concentration in the source water used in Stage 1, amount of MgCO₃ sourced from Stage 1 may vary.

The 8.2 kg of CO₂ gas produced may be collected and add to the CO₂ gas stream produced in Step 6.

Only some amount of hydrochloric acid, equivalent to approximately 13.7 kg of pure HCl, may be consumed in the present step. This consumption may vary depending on amount of CaCO₃ and MgCO₃ sourced from Stage 1.

Where HCl is sourced from Step 7, the rest of HCl left behind after the consumption of some amount of HCl in the present step may be thermally concentrated using heat from Step 5, and be sold or used for alternate purposes.

Step 9 Recover Water from Exhaust Gas (Air/Smoke) of Stage 2 and Stage 3

The approximate 18.2 kg mixture of calcium chloride/magnesium chloride from Step 8 may be collected and used to capture water from exhaust air/smoke from Stage 2 and Stage 3. The chloride salt mixture may also be used for alternate purposes.

Heat from Step 5 may be used to recover pure water for use in this method, where water is scarce. In addition, or apart from the above, heat from Step 5 may be used for thermal desalination of brine, in cases whereby excess brine is still available after Step 7.

Method according to embodiments disclosed herein may be a multi-bucket process to capture CO₂ from water, air and flue gas, in that it uses multiple tanks of water to capture CO₂ from water, from air, and from flue gas, to produce economically valuable products, without using large amounts of energy to move air through alkaline scrubbers. Methods disclosed herein may operate in a thermally more efficient manner, and the outputs produced may be of high purity. Methods according to embodiments disclosed herein are able to re-generate water consumed in the process, and the by-products of this process may be green H₂ and O₂ gas.

In various embodiments, integration of Stage 1 may mean that all the insoluble carbonates and insoluble hydroxides are removed from water, before the water is used for Stage 2 and Stage 3. This may remove most of the cations such as calcium and magnesium from water, and the remaining amount of calcium and magnesium do not cause contamination of ZnCO₃ in Stage 3 when ZnCl₂ is added to Na₂CO₃.

If Stage 1 is not present or skipped, and if the source water has cations like calcium and magnesium, these may form carbonate and hydroxide precipitates and contaminate ZnCO₃. Hence, integration of Stage 1 before Stage 2 and Stage 3 may prevent contamination of ZnCO₃ with carbonates and hydroxides of calcium and magnesium. The same applies if there are other cations such as iron or lead or copper or other cations in water which may be removed by Stage 1. Thus, the ZnCO₃ may be free from contamination in Stage 3.

In various embodiments, Stage 2 may be skipped and directly go to Stage 3. If Stage 2 is present, then Stage 3 may be shortened, because total CO₂ captured by Stage 2 and Stage 3 in combination may be considered in preventing NaCl precipitation so as to avoid contamination of ZnCO₃ in Stage 3. This is advantageous, because contamination of ZnCO₃ with NaCl precipitate may result in additional step(s) being needed to wash ZnCO₃ to remove NaCl, which may add cost and time. By preventing NaCl precipitation and/or removing precipitated NaCl, this may avoid contamination of the ZnO formed, which may otherwise happen if the NaCl is not removed and the contaminated ZnCO₃ is sent into oven for calcining at a temperature of up to 400° C. Accordingly, ZnO of high purity may be produced, so that it may be used commercially. Moreover, this avoids formation of contaminants which may corrode the equipment such as oven and release fumes, which may in turn contaminate the pure stream of humid CO₂ produced by calcining ZnCO₃.

An advantage of running Stage 3 after Stage 2 is that a very high pH may be used to capture CO₂ from air due to the very dilute concentration of CO₂ in air. The air in the vent of the shopping mall or office space where the CO₂ breathed out by humans may increase concentration of CO₂ in air above the concentration of CO₂ in outside ambient air, and may advantageously be used. Even if the contraction of CO₂ is well below 0.1% while the contraction of CO₂ in smoke is about 10%, it may still be about hundred times higher than in air. Consequently, resulting solution of water after Stage 2 may be also at a remarkably high pH of well above 12. However, the smoke may be captured even with low pH water that is well below pH 10. Therefore, the exhaust water from Stage 2 may have a high level of excess NaOH and hence has capacity to capture CO₂ from the smoke in Stage 3 even without adding more NaOH to water coming out of Stage 2. This may help to avoid wastage of NaOH from exhaust water in Stage 2 because it can be consumed in Stage 3.

Methods in this Example D may be exemplified by the following statements 1 to 30.

Statement 1: A method for capturing carbon dioxide from an aqueous liquid and a gas, the method comprising, treating the aqueous liquid that has at least some dissolved carbon dioxide with an alkali metal hydroxide and an alkali metal carbonate to obtain a first capture medium having a pH of at least 10.5, the aqueous liquid being placed in a closed environment so as to at least minimize contact with ambient air, wherein the precipitate(s), if any are formed, are removed, whereafter the aqueous liquid is placed in open environment to allow contact with ambient air, wherein the alkali or alkaline earth metal hydroxide reacts with carbon dioxide now present in the aqueous liquid to form a first carbonate or bicarbonate, wherein the first carbonate is the same compound as the alkali metal carbonate, and contacting the first capture medium with the gas to obtain a second capture medium, wherein the first capture medium reacts with carbon dioxide present in the gas to form further quantities of the first carbonate in the second capture medium.

Statement 2: The method according to statement 1, wherein the aqueous liquid comprises water with total hardness of at least 1 ppm.

Statement 3: The method according to statement 1 or 2, wherein treating the aqueous liquid comprises treating the aqueous liquid with a non-carbonic acid to adjust pH of the aqueous liquid to below 4 prior to treating the aqueous liquid with the alkali metal hydroxide and the alkali metal carbonate.

Statement 4: The method according to any one of statements 1 to 3, wherein the aqueous liquid comprises cations which are capable of reacting with the alkali metal carbonate or bicarbonate to form a second precipitate and cations which are capable of reacting with the alkali metal hydroxide to form a first precipitate.

Statement 5: The method according to statement 4, wherein treating the aqueous liquid comprises (a) contacting the aqueous liquid with the alkali metal hydroxide to form the first precipitate and removing the first precipitate from the aqueous liquid, before contacting the resultant aqueous liquid with the alkali metal carbonate or bicarbonate to form the second precipitate, or (b) contacting the aqueous liquid with the alkali metal carbonate or bicarbonate to form the second precipitate and removing the second precipitate from the aqueous liquid, before contacting the resultant aqueous liquid with the alkali metal hydroxide to form the first precipitate.

Statement 6: The method according to statement 5, further comprising removing the first precipitate and/or the second precipitate from the first capture medium before contacting the first capture medium with the gas.

Statement 7: The method according to any one of statements 1 to 6, wherein the alkali metal carbonate is sodium carbonate and the alkali metal hydroxide is sodium hydroxide and the alkaline earth metal hydroxide is calcium hydroxide.

Statement 8: The method according to any one of statements 4 to 7, wherein the first precipitate comprises a second carbonate in an amount of at least 95 wt %, and/or the second precipitate comprises a hydroxide in an amount of at least 95 wt %.

Statement 9: The method according to any one of statements 1 to 8, wherein treating the aqueous liquid with the alkali metal hydroxide is carried out until the aqueous liquid reaches a pH of at least 10.5.

Statement 10: The method according to any one of statements 1 to 8, wherein treating the aqueous liquid with the alkali metal hydroxide is carried out until the aqueous liquid reaches a pH of at least 13.5.

Statement 11: The method according to any one of statements 1 to 10, wherein contacting the first capture medium with the gas comprises adding further quantities of the alkali metal hydroxide to the first capture medium prior to or during the contacting.

Statement 12: The method according to any one of statements 1 to 11, wherein contacting the first capture medium with the gas comprises treating the first capture medium with an alkaline earth metal chloride at either one or more of: prior to, during, or after contacting of the first capture medium with the gas.

Statement 13: The method according to statement 12, wherein treating the first capture medium with the alkaline earth metal chloride forms a precipitate, the method further comprising removing the precipitate from the first capture medium.

Statement 14: The method according to statement 12 or 13, wherein the alkaline earth metal chloride comprises strontium chloride.

Statement 15: The method according to any one of statements 1 to 14, wherein the gas is one or more of ambient air and a flue gas or CO₂ gas released during the method.

Statement 16: The method according to any one of statements 1 to 15, wherein contacting the first capture medium with the gas comprises contacting the first capture medium with ambient air, and contacting the resultant first capture medium with a flue gas.

Statement 17: The method according to statement 16, wherein contacting the resultant first capture medium with a flue gas comprises adding further quantities of the alkali metal hydroxide to the resultant first capture medium prior to or during the contacting.

Statement 18: The method according to statement 16 or 17, wherein contacting the first capture medium with ambient air and contacting the resultant first capture medium with a flue gas form respective further quantities of the first carbonate which precipitate out, the method further comprising one or more of (a) removing the precipitate comprising the first carbonate from the resultant first capture medium prior to contacting the resultant first capture medium with the flue gas, and (b) removing the precipitate comprising the first carbonate from the second capture medium.

Statement 19: The method according to statement 18, wherein removing the precipitate comprising the first carbonate from the second capture medium comprises contacting the second capture medium with the flue gas while the precipitate comprising the first carbonate is being removed, and contacting the removed precipitate comprising the first carbonate with an aqueous medium comprising a metal salt, wherein the first carbonate comprised in the removed precipitate reacts with the metal salt to form a metal carbonate and a metal hydroxide, both of which precipitate out from the second capture medium as a mixture.

Statement 20: The method according to any one of statements 1 to 18, further comprising treating the second capture medium with a metal salt, wherein the metal salt reacts with the first carbonate to form a metal carbonate and a metal hydroxide, both of which precipitate out from the second capture medium as a mixture.

Statement 21: The method according to statement 20, wherein the metal salt comprises a metal chloride, preferably zinc chloride or zinc sulphate.

Statement 22: The method according to any one of statements 19 to 21, further comprising calcining the mixture comprising the metal carbonate and the metal hydroxide at a temperature in the range from 250° C. to 400° C.

Statement 23: The method according to statement 22, wherein the mixture comprises calcium oxide, wherein calcining the mixture comprises using heat derived from hydration of the calcium oxide to calcium hydroxide for the calcining.

Statement 24: An integrated system for capturing carbon dioxide from an aqueous liquid and a gas, the system comprising a first capture unit operable to receive an aqueous liquid and to capture carbon dioxide from the aqueous liquid, wherein capturing carbon dioxide from the aqueous liquid comprises treating the aqueous liquid with an alkali metal hydroxide and an alkali metal carbonate to obtain a first capture medium having a pH of at least 10.5, the aqueous liquid being placed in a closed environment so as to at least minimize contact with ambient air, wherein the precipitate(s), if any are formed are removed, whereafter the aqueous liquid is placed in an open environment to allow contact with ambient air, wherein the alkali metal hydroxide reacts with carbon dioxide now present in the aqueous liquid to form a first carbonate, wherein the first carbonate is the same compound as the alkali metal carbonate, and a second capture unit operable to receive the first capture medium from the first capture module and to capture carbon dioxide from a gas, wherein capturing carbon dioxide from the gas comprises contacting the first capture medium with the gas to obtain a second capture medium, wherein the first capture medium reacts with carbon dioxide present in the gas to form further quantities of the first carbonate in the second capture medium.

Statement 25: The integrated system according to statement 24, wherein the second capture unit is operable to receive ambient air for contacting with the first capture medium, and to receive a flue gas for contacting with the resultant first capture medium after contact of the first capture medium with the ambient air.

Statement 26: The integrated system according to statements 24 or 25, further comprising a separation unit operable to receive one or more of the first capture medium and the second capture medium and to remove precipitate from said capture medium.

Statement 27: The integrated system according to statement 26, wherein the separation unit is operable to receive the second capture medium while contact of the second capture medium with the flue gas is being carried out to remove precipitate from the second capture medium, wherein the precipitate comprises the first carbonate, wherein the integrated system further comprises a reaction unit operable to receive the precipitate comprising the first carbonate and a metal salt, wherein the metal salt reacts with the first carbonate to form a metal carbonate and a metal hydroxide which precipitate out from the second capture medium as a mixture.

Statement 28: The integrated system according to any one of statements 24 to 27, wherein the second capture unit is further operable to receive a metal salt, wherein the metal salt reacts with the first carbonate to form a metal carbonate and a metal hydroxide which precipitate out from the second capture medium as a mixture.

Statement 29: The integrated system according to statement 27 or 28, further comprising a calcination unit operable to calcine the mixture comprising the metal carbonate and the metal hydroxide at a temperature in the range from 250° C. to 400° C.

Statement 30: Use of the method according to any one of statements 1 to 23 or the integrated system according to any one of statements 24 to 29 in one or more of treatment of water, ambient air, and flue gas, and carbon dioxide recovery.

By “comprising” it is meant including, but not limited to, whatever follows the word “comprising”. Thus, use of the term “comprising” indicates that the listed elements are required or mandatory, but that other elements are optional and may or may not be present.

By “consisting of” is meant including, and limited to, whatever follows the phrase “consisting of”. Thus, the phrase “consisting of” indicates that the listed elements are required or mandatory, and that no other elements may be present.

The inventions illustratively described herein may suitably be practiced in the absence of any element or elements, limitation or limitations, not specifically disclosed herein. Thus, for example, the terms “comprising”, “including”, “containing”, etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the inventions embodied therein herein disclosed may be resorted to by those skilled in the art, and that such modifications and variations are considered to be within the scope of this invention.

By “about” in relation to a given numerical value, such as for temperature and period of time, it is meant to include numerical values within 10% of the specified value.

The invention has been described broadly and generically herein. Each of the narrower species and sub-generic groupings falling within the generic disclosure also form part of the invention. This includes the generic description of the invention with a proviso or negative limitation removing any subject matter from the genus, regardless of whether or not the excised material is specifically recited herein.

Other embodiments are within the following claims and non-limiting examples. In addition, where features or aspects of the invention are described in terms of Markush groups, those skilled in the art will recognize that the invention is also thereby described in terms of any individual member or subgroup of members of the Markush group.

1. A method for capturing carbon, comprising a process cycle of:
a carbonization process, comprising enriching a feed comprising an aqueous medium with carbon from a carbon dioxide source to form a carbon-rich aqueous medium comprising carbonate ions, and
a decarbonization process, comprising removing carbon from the carbon-rich aqueous medium by treating the carbon-rich aqueous medium with a cation capable of forming an insoluble carbonate with the carbonate ions, and removing the insoluble carbonate to form a carbon-deficient aqueous medium; and
wherein the method comprises carrying out the process cycle for multiple times, with the carbon-deficient aqueous medium of a preceding stage making up the feed for the enriching in a subsequent stage, wherein each of the multiple times uses one or more of (a) a different carbon dioxide source, (b) a different pH, and (c) a different cation, and
wherein when carrying out the process cycle for a first time, the aqueous medium comprised in the feed is water, and the carbon dioxide source comprises ambient air; and
wherein when carrying out the process cycle for a second time, the carbon dioxide source is flue gas from a combustion chamber or a biogas with a high concentration of carbon dioxide, and wherein output gas from carrying out the process cycle for the second time is comprised in the carbon dioxide source when carrying out the process cycle for the first time.

2. The method according to claim 1, wherein the method further comprises, prior to carrying out the process cycle for a first time,
pre-treating the feed comprising the aqueous medium with an acid to achieve a pH value of 4 or less, and subsequently treating with an alkali to increase its pH to 10.5 or more, and
removing any carbon dioxide evolved and precipitate formed as a result of the pre-treating, wherein preferably, a carbon dioxide gas forms at least part of the carbon dioxide source when carrying out the process cycle for a third or subsequent time.

3. The method according to claim 1, wherein the method comprises carrying out the process cycle for three times or more.

4. The method according to claim 1, wherein carrying out the process cycle for a first time comprises enriching the feed by contacting the feed with the carbon dioxide source, and treating the feed with an alkali while the contacting is carried out to form the carbon-rich aqueous medium comprising carbonate ions, wherein the carbon-rich aqueous medium has a pH value of at least 11.5.

5. The method according to claim 1, wherein carrying out the process cycle for a first time comprises removing carbon from the carbon-rich aqueous medium by treating the carbon-rich aqueous medium with an alkaline earth cation to form an insoluble alkaline earth carbonate, wherein treating the carbon-rich aqueous medium with an alkaline earth cation is carried out while the carbon-rich aqueous medium is contacted with the carbon dioxide source, and removing the insoluble carbonate to form the carbon-deficient aqueous medium, wherein the carbon-deficient aqueous medium has a pH value of 10.3 or below.

6. The method according to claim 1, wherein the carbon dioxide source when carrying out the process cycle for the second time comprises SOx.

7. The method according to claim 6, wherein carrying out the process cycle for a second time comprises enriching the feed by contacting the feed with the carbon dioxide source, and treating the feed with an alkali while the contacting is carried out to form the carbon-rich aqueous medium comprising carbonate ions, wherein the carbon-rich aqueous medium further comprises hydroxide ions.

8. The method according to claim 6, wherein carrying out the process cycle for a second time comprises removing carbon from the carbon-rich aqueous medium by treating the carbon-rich aqueous medium with a cation capable of forming an insoluble carbonate but incapable of forming an insoluble sulphate in a presence of carbonate ions and excess hydroxide ions, wherein the cation is provided by a highly soluble halide salt such as a chloride salt, a sulphate salt, or a highly soluble nitrate salt, and removing the insoluble carbonate as a precipitate to form a carbon-deficient aqueous medium.

9. The method according to claim 8, further comprising subjecting the precipitate to a heat treatment to release steam, or CO₂ gas, or a mixture of steam and CO₂ gas, wherein preferably, thermal energy for the heat treatment comprises thermal energy channeled from carrying out the process cycle for a first time.

10. The method according to claim 9, wherein the heat treatment is carried out at a temperature in a range from 150 to 400° C. in an enclosed environment.

11. The method according to claim 9, wherein thermal energy is recovered from a steam and/or CO₂ gas, and the thermal energy is used along with thermal energy recovered from other process cycles for the heat treatment, and/or one or more of the carbonization process and the decarbonization process, and/or pre-treating of the feed if the pre-treating is carried out, and/or heating precipitate formed from one or more of the process cycles.

12. The method according to claim 9, wherein CO₂ gas is released, and the CO₂ gas forms at least part of the carbon dioxide source when carrying out the process cycle for a third or subsequent time.

13. The method according to claim 8, wherein the carbon-deficient aqueous medium comprises sulphate ions, the method further comprising treating the carbon-deficient aqueous medium with a cation capable of forming an insoluble sulphate with the sulphate ions, wherein the cation is provided by a hydroxide salt or a halide salt such as a chloride salt or a highly soluble nitrate salt, and removing the insoluble sulphate to form a carbon-deficient aqueous medium, wherein the carbon-deficient aqueous medium is also sulphate-deficient.

14. The method according to claim 13, wherein carrying out the process cycle for a third time comprises enriching the carbon-deficient aqueous medium by contacting the feed with the carbon dioxide source, and treating the feed with an alkali or a basic salt while the contacting is carried out to form the carbon-rich aqueous medium comprising carbonate ions, wherein the carbon dioxide source is one or more of ambient air, purified CO₂ gas, a sulphur-free target gas, and carbonate ions, and wherein precipitate if formed is removed.

15. The method according to claim 1, wherein carrying out the process cycle for a third time further comprising generating an alkali and output water with reduced concentration of salt from the carbon-deficient aqueous medium by using electrical energy, wherein the carbon-deficient aqueous medium is in a form of a brine containing a sufficiently high concentration of dissolved salts produced after carrying out the process cycle for a third time, wherein the alkali is channeled to a different process cycle for use, and the output water is channeled into a carbonisation cycle when carrying out the process cycle for a first time.

16. The method according to claim 1, further comprising using the carbon-deficient aqueous medium formed in the decarbonization process when carrying out the process cycle for a second and subsequent times, as at least part of the aqueous medium of the carbonization process when carrying out the process cycle for the first time.

17. The method according to claim 16, further comprising treating the carbon-deficient aqueous medium to one or more of (a) a reverse-osmosis process and (b) distillation process, before using the treated carbon-deficient aqueous medium as at least part of the aqueous medium of the carbonization process when carrying out the process cycle for the first time, wherein preferably, precipitates formed during one or more of the process cycles act as a heat sink for condensation of water vapour in the distillation process.

18. The method according to claim 1, wherein thermal energy is generated from one or more of the process cycle, and the thermal energy is channeled to a different process cycle for use.

19. An integrated system for capturing carbon, comprising:
a carbonization unit operable to enrich a feed comprising an aqueous medium with carbon from a carbon dioxide source to form a carbon-rich aqueous medium comprising carbonate ions, and
a decarbonization unit operable to remove carbon from the carbon-rich aqueous medium by treating the carbon-rich aqueous medium with a cation capable of forming an insoluble carbonate with the carbonate ions, and removing the insoluble carbonate to form a carbon-deficient aqueous medium; and
wherein each carbonization unit and decarbonization unit are adapted to use one or more of (a) a different carbon dioxide source, (b) a different pH, and (c) a different cation, and
wherein the carbonization unit and decarbonization unit are operable for the aqueous medium comprised in the feed when carrying out a process cycle for a first time to be water, the carbon dioxide source when carrying out the process cycle for the first time to comprise ambient air, the carbon dioxide source when carrying out the process cycle for a second time to be flue gas from a combustion chamber or a biogas with a high concentration of carbon dioxide, and for output gas from carrying out the process cycle for the second time to be comprised in the carbon dioxide source when carrying out the process cycle for the first time.

20. The integrated system according to claim 19, wherein the integrated system is used in one or more of treatment of water, ambient air, and flue gas, and carbon dioxide recovery.
